(19) United States
(12) Patent Application Publication
(10) Pub. No.: US 2016/0265920 A1
(43) Pub. Date: Sep. 15, 2016

(54) DEVICE, PROGRAM, RECORDING MEDIUM AND METHOD FOR FACILITATING DETERMINATION OF BUNKERING PORT AND BUNKERING AMOUNT FOR SHIP

(71) Applicant: NIPPON YUSEN KABUSHIKI KAISHA, Tokyo (JP)

(72) Inventors: Atsushi YAMAGUCHI, Tokyo (JP); Masaharu URABE, Tokyo (JP); Ryo KAKUTA, Tokyo (JP)

(73) Assignee: NIPPON YUSEN KABUSHIKI KAISHA, Tokyo (JP)

(21) Appl. No.: 15/033,229

(22) PCT Filed: Oct. 31, 2013
(86) PCT No.: PCT/JP2013/079507

§ 371 Date: Apr. 29, 2016

(51) Int. Cl. G01C 21/20; B63B 49/00

(52) U.S. Cl. CPC G01C 21/20; B63B 49/00

(57) ABSTRACT

The present invention provides an arrangement for providing a bunkering plan (bunkering ports and bunkering amounts at the bunkering ports) that reduces fuel costs in a voyage of a ship. According to one embodiment of the present invention, if a bunkering plan that brings about a lower fuel costs according to the current bunkering plan occurs in accordance with the change in fuel price at a specific port, for example, for a ship that is being sailed, a user such as a ship operation manager is notified of this event. Accordingly, a user is able to know easily which bunkering plan is suitable.

### FIELD

The present invention pertains to a technique for facilitating determination of a bunkering port and bunkering amount for a ship.

### BACKGROUND

In planning a voyage for a ship, a wide range of factors are taken into consideration, such as: a route to be taken from a point of departure to a point of destination; ports of call to be included in the voyage; and a sailing speed between ports. Factors involved in planning a voyage such as those mentioned above affect both costs incurred and profits obtained in the voyage.

Arrangements for planning a voyage for a ship with an object of maximizing profit are proposed. For example, JP2010-001114A proposes an arrangement for specifying an optimum order in which ports of call are stopped at and an optimum number of voyages along a route based on a volume of cargo to be transported by a plurality of ships (fleet) within a predetermined period, and planning a shipping operation that enables the ships to implement the specified number of voyages along the route within the predetermined period and to arrive at each of unloading ports along the sailing route at regular intervals.

In a voyage of a ship, when an amount of fuel loaded on the ship is increased, fuel consumption per distance unit when sailing at the same sailing speed also increases. Therefore, from the perspective of reducing fuel consumption, it is desirable to load the ship with the minimum amount of fuel required to reach the next port at which bunkering is possible on the sailing route of the voyage.

However, even if an amount of fuel consumed over an entire voyage is minimized, actual fuel costs are not necessarily minimized. This is because fuel prices can differ greatly from one port to another. For example, when a ship calls at port A and then port B, at each of which bunkering is possible, it is possible to reduce the overall fuel costs by taking on a larger amount of fuel at port A under a condition that the fuel price at port A is cheaper than the fuel price at port B by a sufficient amount to compensate for an increase in fuel consumption generated by carrying the larger amount of fuel during a sail from port A to port B.

Therefore, a ship operation manager, a ship navigator or the like who manages the voyage of a ship needs to know how much fuel should be taken on and at which port(s), to minimize fuel costs over the entire voyage.

### SUMMARY

In view of the situation described above, the present invention has, as an object, the provision of a means of enabling a user who manages the voyage of a ship to determine at which port(s) bunkering should take place and an amount of fuel that should be taken on, with a view to reducing overall fuel costs.

To solve the problem stated above, the present invention provides a device comprising: a fuel consumption acquisition unit that acquires fuel consumption data indicating fuel consumption per distance unit corresponding to sailing speed of a ship; a port-to-port distance acquisition unit that acquires, for each of a plurality of ports, port-to-port distance data indicating a distance between the port and one or more ports other than the port from among the plurality of ports; a voyage plan acquisition unit that acquires voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports; an remaining fuel condition acquisition unit that acquires remaining fuel condition data indicating conditions related to an amount of fuel remaining on the ship while the ship is sailing the sailing route indicated by the voyage plan data; a remaining fuel acquisition unit that acquires remaining fuel data indicating a current amount of fuel remaining on the ship; a fuel price acquisition unit that acquires fuel price data indicating a fuel price at each of a plurality of bunkering ports at which bunkering of the ship is possible from among the plurality of ports; a bunkering plan generation unit that generates bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data; a fuel costs calculation unit that calculates fuel costs in the bunkering plan indicated by the bunkering plan data based on the bunkering plan data and the fuel price data, and generates fuel cost data indicating the fuel costs; a notification data generation unit that generates notification data indicating the bunkering plan indicated by the bunkering plan data and the fuel costs indicated by the fuel cost data; and an output unit that outputs the notification data.

In the device described above, a configuration may be adopted in which: the bunkering plan generation unit, if any of the fuel consumption data, the port-to-port distance data, the voyage plan data, the remaining fuel condition data and the remaining fuel data is modified, modifies the bunkering plan data based on the modified data, the fuel cost calculation unit, if the bunkering plan data or the fuel price data is modified, modifies the fuel cost data based on the modified data, the notification data generation unit, if the bunkering plan data or the fuel cost data is modified, generates notification data after modification indicating notification of the bunkering plan or the fuel costs indicated by the modified data, and the output unit outputs the notification data after modification.

In the device described above, a configuration may be adopted in which: the bunkering plan generation unit, if a plurality of bunkering plans are specified, generates a plurality of sets of bunkering plan data each indicating any of the plurality of bunkering plans, the fuel cost calculation unit, if a plurality of sets of bunkering plan data is generated by the bunkering plan generation unit, calculates, in connection with each of the plurality of sets of bunkering plan data, fuel costs for a bunkering plan indicated by the set of bunkering plan data based on the set of bunkering plan data and the fuel price data, and generates fuel cost data indicating the calculated fuel costs, and the notification data generation unit, if a plurality of sets of fuel cost data is generated by the fuel costs calculation unit, generates notification data indicating minimum fuel costs indicated by each of the plurality of sets of fuel cost data, and a bunkering plan indicated by a bunkering plan data corresponding to a set of fuel cost data indicating the minimum fuel costs.

In the device described above, a configuration may be adopted in which: the remaining fuel condition data indicates, under a condition in which bunkering is not carried out at a predetermined number of bunkering ports from among the one or more bunkering ports selected as bunkering ports at which bunkering of the ship should be carried out, a condition that either fuel amount required for the ship to sail on the sailing route indicated by the voyage plan data is equivalent to the amount of fuel remaining, or the amount of fuel remaining exceeds the fuel amount required.

In the device described above, a configuration may be adopted in which: the fuel consumption data indicates fuel consumption per distance unit corresponding to a combination of sailing speed of the ship and marine or weather condition elements that affect fuel consumption when the ship sails at a same sailing speed, the device further comprises a weather and marine element acquisition unit that acquires weather and marine element data indicating elements related to weather or marine conditions in the voyage plan indicated by the voyage plan data, and the bunkering plan generation unit specifies, based on the fuel consumption data, fuel consumption when the ship sails on the sailing route indicated by the voyage plan data at the sailing speed indicated by the voyage plan data under a weather or marine condition with the elements indicated by the weather and marine element data, and generates the bunkering plan data based on the specified fuel consumption.

In the device described above, a configuration may be adopted in which: the fuel consumption data indicates fuel consumption per distance unit corresponding to at least one of draft and trim of the ship, the bunkering plan generation unit is provided with a reference data acquisition unit that acquires reference data indicating a reference value for at least one of draft and trim corresponding to loaded amount including at least one of loaded amount of cargo and loaded amount of fuel remaining on the ship, and the bunkering plan generation unit specifies, based on the fuel consumption data, fuel consumption when the ship with at least one of draft and trim specified based on loaded amount of the ship sails on the sailing route indicated by the voyage plan data at the sailing speed indicated by the voyage plan data, and generates the bunkering plan data based on the specified fuel consumption.

In the device described above, a configuration may be adopted in which: the device further comprises a remaining distance to be sailed acquisition unit that acquires remaining distance to be sailed data indicating a distance from a current position of the ship to a port at which the ship calls next, and the bunkering plan generation unit generates the bunkering plan data based on the remaining distance to be sailed data.

In the device described above, a configuration may be adopted in which: the voyage plan data indicates, with regard to each of one or more ports of call at which the ship calls from among the plurality of ports, a time at which the ship arrives at the port of call and a time at which the ship departs from the port of call, and the bunkering plan generation unit specifies a bunkering plan in which one or more of the one or more ports of call on the sailing route indicated by the voyage plan data are selected as bunkering ports at which the ship is bunkered.

The present invention provides a program for causing a computer to execute: a process for acquiring fuel consumption data indicating fuel consumption per distance unit corresponding to sailing speed of a ship; a process for acquiring, for each of a plurality of ports, port-to-port distance data indicating a distance between the port and one or more ports other than the port from among the plurality of ports; a process for acquiring voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports; a process for acquiring remaining fuel condition data indicating conditions related to an amount of fuel remaining on the ship while the ship is sailing the sailing route indicated by the voyage plan data; a process for acquiring remaining fuel data indicating a current amount of fuel remaining on the ship; a process for acquiring fuel price data indicating a fuel price at each of a plurality of bunkering ports at which bunkering of the ship is possible from among the plurality of ports; a process for generating bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data; a process for calculating fuel costs in the bunkering plan indicated by the bunkering plan data based on the bunkering plan data and the fuel price data, and generating fuel cost data indicating the fuel costs; a process for generating notification data indicating the bunkering plan indicated by the bunkering plan data and the fuel costs indicated by the fuel cost data; and a process for outputting the notification data.

The present invention provides a computer-readable recording medium that continuously records a program for causing a computer to execute: a process for acquiring fuel consumption data indicating fuel consumption per distance unit corresponding to sailing speed of a ship; a process for acquiring, for each of a plurality of ports, port-to-port distance data indicating a distance between the port and one or more ports other than the port from among the plurality of ports; a process for acquiring voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports; a process for acquiring remaining fuel condition data indicating conditions related to an amount of fuel remaining on the ship while the ship is sailing the sailing route indicated by the voyage plan data; a process for acquiring remaining fuel data indicating a current amount of fuel remaining on the ship; a process for acquiring fuel price data indicating a fuel price at each of a plurality of bunkering ports at which bunkering of the ship is possible from among the plurality of ports; a process for generating bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data; a process for calculating fuel costs in the bunkering plan indicated by the bunkering plan data based on the bunkering plan data and the fuel price data, and generating fuel cost data indicating the fuel costs; a process for generating notification data indicating the bunkering plan indicated by the bunkering plan data and the fuel costs indicated by the fuel cost data; and a process for outputting the notification data.

The present invention provides a method comprising: a step for a device to acquire fuel consumption data indicating fuel consumption per distance unit corresponding to sailing speed of a ship; a step for the device to acquire, for each of a plurality of ports, port-to-port distance data indicating a distance between the port and one or more ports other than the port from among the plurality of ports; a step for the device to acquire voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports; a step for the device to acquire remaining fuel condition data indicating conditions related to an amount of fuel remaining on the ship while the ship is sailing the sailing route indicated by the voyage plan data; a step for the device to acquire remaining fuel data indicating a current amount of fuel remaining on the ship; a step for the device to acquire fuel price data indicating a fuel price at each of a plurality of bunkering ports at which bunkering of the ship is possible from among the plurality of ports; a step for the device to generate bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data; a step for the device to calculate fuel costs in the bunkering plan indicated by the bunkering plan data based on the bunkering plan data and the fuel price data, and generate fuel cost data indicating the fuel costs; a step for the device to generate notification data indicating the bunkering plan indicated by the bunkering plan data and the fuel costs indicated by the fuel cost data; and a step for the device to output the notification data.

According to the present invention, when a ship sails a sailing route according to a voyage plan, a port(s) at which bunkering should take place and an amount of fuel that should be loaded are specified so as to satisfy conditions relating to an amount of fuel remaining, such as an amount of fuel remaining should be greater than or equal to the amount of fuel required for sailing to the next port of call, the fuel costs resulting from the specified amount of fuel being loaded at the specified port is calculated, and a user is notified of this information. Therefore, a user is able to specify a bunkering port(s) and bunkering amount so as to achieve lower fuel costs by comparing fuel costs corresponding to a plurality of combinations of bunkering ports and bunkering amounts that are presented as options, for example.

### BRIEF EXPLANATION OF THE DRAWINGS

FIG. 1 A drawing illustrating an overall configuration of a bunkering plan support system as in one embodiment of the present invention.

FIG. 2 A drawing exemplifying a screen presented to a user in a bunkering plan support system as in one embodiment of the present invention.

FIG. 3 A drawing exemplifying a screen presented to a user in a bunkering plan support system as in one embodiment of the present invention.

FIG. 4 A drawing illustrating the configuration of a computer used as hardware of the weather and marine information distribution server device, the terminal device, and the bunkering plan management server device as in one embodiment of the present invention.

FIG. 5 A block diagram illustrating a functional configuration of a bunkering plan management server device as in one embodiment of the present invention.

FIG. 6 A drawing illustrating a configuration of fuel consumption data used in a bunkering plan management server device as in one embodiment of the present invention.

FIG. 7 A drawing illustrating a structure of port-to-port distance data used in a bunkering plan management server device as in one embodiment of the present invention.

FIG. 8 A drawing illustrating a structure of draft trim reference data used in a bunkering plan management server device as in one embodiment of the present invention.

FIG. 9 A drawing illustrating a configuration of voyage plan data used in a bunkering plan management server device as in one embodiment of the present invention.

FIG. 10 A drawing illustrating a configuration of remaining fuel condition data used in a bunkering plan management server device as in one embodiment of the present invention.

FIG. 11 A drawing illustrating a configuration of voyage restriction data in a bunkering plan management server device as in one embodiment of the present invention.

FIG. 12 Values specified based on fuel price data used in a bunkering plan management server device as in one embodiment of the present invention.

FIG. 13 A drawing illustrating a configuration of weather and marine element data used in a bunkering plan management server device as in one embodiment of the present invention.

FIG. 14 A drawing illustrating a structure of current status data used in a bunkering plan management server device as in one embodiment of the present invention.

FIG. 15 A drawing illustrating a process flow carried out by a bunkering plan management server device as in one embodiment of the present invention.

FIG. 16 A table for explaining a method for specifying a bunkering pattern performed by a bunkering plan management server device as in one embodiment of the present invention.\

FIG. 17A A drawing illustrating a process flow performed by a bunkering plan management server device as in one embodiment of the present invention.

FIG. 17B A drawing illustrating the process flow performed by a bunkering plan management server device as in one embodiment of the present invention.

FIG. 18 A drawing illustrating a configuration of alternative voyage plan data used in a bunkering plan management server device as in one embodiment of the present invention.

FIG. 19 A drawing illustrating a process flow performed by a bunkering plan management server device as in one embodiment of the present invention.

### DETAILED DESCRIPTION

### 1. Embodiment

The configuration and process of a bunkering plan support system 1 as in one embodiment of the present invention are explained below. Bunkering plan support system 1 is a system that presents, to a user such as a ship operation manager or a ship navigator, a cost-effective bunkering plan for a voyage of a ship. A bunkering plan signifies a combination of one or more bunkering ports at which bunkering actually takes place from among a large number of ports at which bunkering of ships is possible (hereafter referred to as “bunkering ports”), and a bunkering amount at each of the one or more bunkering ports.

In bunkering plan support system 1, in addition to ports at which bunkering is possible (that is to say, bunkering ports that are ports of call) from among ports of call for cargo handling and the like (hereafter referred to as “ports of call”), bunkering ports within a predetermined distance from a point on the sailing route from the departure port (hereafter referred to as “departure point”) to the destination port (hereafter referred to as “destination”) via the ports of call (that is to say, bunkering ports that are not ports of call) are also selected as candidate bunkering ports in the bunkering plan.

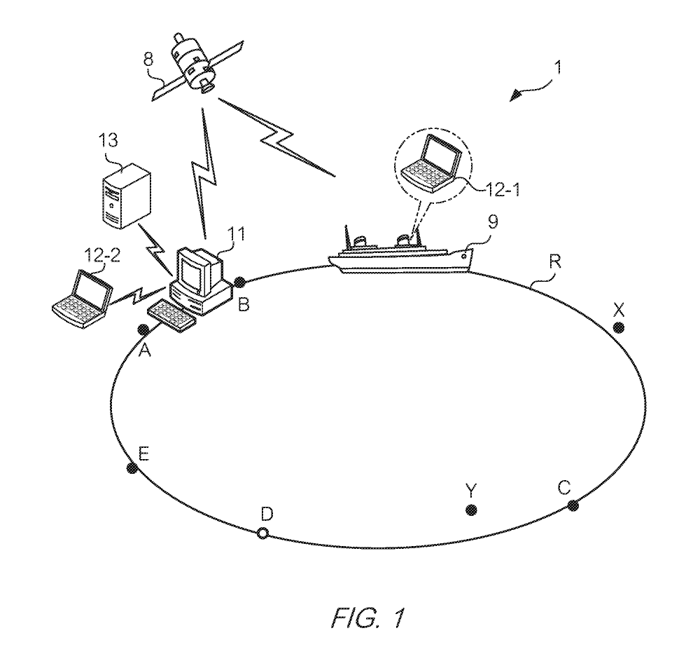

FIG. 1 is a drawing schematically illustrating the overall configuration of bunkering plan support system 1. Bunkering plan support system 1 is provided with a bunkering plan management server device 11 that is operated by a ship operation manager, for example, a ship terminal device 12-1 that is mounted on a ship 9 and operated by a ship navigator, or a land-side terminal device 12-2 that supports the operation of ship 9 from land and that is operated by a ship operation manager or the like, and a weather and marine information distribution server device 13 that transmits, to bunkering plan management server device 11, data indicating current and future weather and marine elements (hereafter referred to as “weather and marine element data”) in response to a transmission request from bunkering plan management server device 11.

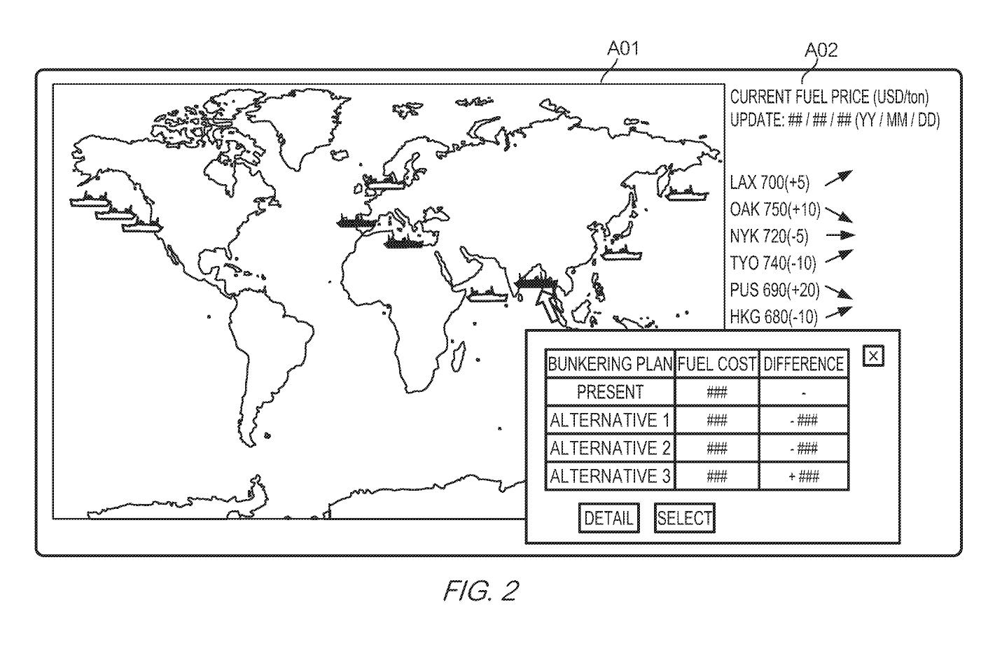

FIG. 1 is an illustration for the voyage of a single ship 9, but bunkering plan support system 1 can simultaneously manage bunkering plans for individual voyages of a plurality of ships 9 (routes may differ from one another). That is to say, a number of ship terminal devices 12-1 that constitute bunkering plan support system 1 varies according to a number of voyages managed by bunkering plan support system 1. However, apart from the explanation of the list screen (FIG. 2), which will be mentioned later, the explanation below relates to a voyage R of a single ship 9.

Bunkering plan management server device 11 is a server device that manages a bunkering plan for voyage R of ship 9, is equipped with a Web server function, and makes possible viewing and the like of bunkering plans from ship terminal device 12-1 and land-side terminal device 12-2. Bunkering plan management server device 11 also functions as a terminal device that is directly operated by a user such as a ship operation manager.

Ship terminal device 12-1 transmits, to bunkering plan management server device 11, different types of data (hereafter referred to as “current status data”) indicating an amount of fuel remaining (an amount of fuel loaded on ship 9 at that point in time) and the like measured on ship 9 or input by a ship navigator or the like, is provided with a browser function, and accesses bunkering plan management server device 11 to display or otherwise indicate bunkering plans. Bunkering plan management server device 11 and ship terminal device 12-1 perform data communication via a communication satellite 8.

Land-side terminal device 12-2 is provided with a browser function, and accesses bunkering plan management server device 11 to display or otherwise indicate bunkering plans. Since ship terminal device 12-1 and land-side terminal device 12-2 have the same hardware configuration and the majority of operations are the same, hereafter, if there is no distinction made between the two, the two devices are referred to as “terminal device 12”.

FIG. 1 exemplifies the performance of voyage R in which ship 9 departs port A, which is the departure point, and subsequently calls at ports of call, i.e. port B, port C, port D and port E in that order, where cargo handling or the like is carried out, before arriving at port A, which is the destination. In FIG. 1, ports shown by black circles are bunkering ports, and ports shown by white circles are non-bunkering ports. Therefore, from among the ports of call of voyage R, port D is not a bunkering port, while the other ports are bunkering ports. Port X and port Y, which are bunkering ports that are not ports of call, are located in the vicinity (within the range of a predetermined distance) of the sailing route of voyage R exemplified in FIG. 1.

Before explaining each of the devices that constitute bunkering plan support system 1, the type of information provided to a ship operation manager, a ship navigator or the like (hereafter referred to as “user”) by bunkering plan support system 1 is explained.

FIG. 2 is a drawing exemplifying a list screen displayed on a display (built-in or external) of bunkering plan management server device 11 or terminal device 12 in bunkering plan support system 1. The list screen is provided with a region A01 indicating a current position of each of a plurality of ships 9 for which a bunkering plan is managed by bunkering plan support system 1. In region A01, a world map is displayed as a background image, and a ship icon corresponding to ship 9 is displayed in a position corresponding to the current position of each of ships 9 on the world map. Ship icons displayed in region A01, for which a bunkering plan has been discovered that is more desirable than the bunkering plan currently adopted in the voyage of ship 9, are displayed in a different display mode to those of the other ship icons. In FIG. 2, as an example, ships 9 that are undertaking a voyage for which a bunkering plan has been discovered that is more desirable than the bunkering plan that is currently adopted are displayed as black ship icons, while other ships 9 are displayed as white ship icons.

The list screen is provided with a region A02 indicating the current fuel price at each of the bunkering ports. In FIG. 2, symbols such as “LAX” indicate identification symbols (abbreviations) of the bunkering ports, and the figure to the right thereof indicates the fuel price (USD/ton). The figure in brackets to the right of the fuel price indicates the increase/decrease from the fuel price on the previous business day, and the arrow to the right thereof indicates the trend in price variation

If a user double-clicks, for example, any of the ship icons displayed in region A01, the list screen displays a pop-up screen above regions A01 and A02. The pop-up screen lists the fuel costs required until the completion of a voyage when the bunkering plan that is currently in use corresponding to the icon double-clicked or the like by the user (hereafter referred to as “present bunkering plan”) is followed, and the fuel costs for the three alternative bunkering plans (hereafter referred to as “alternative bunkering plans”) with the lowest fuel costs, along with the difference between these expenses and the fuel costs according to the present bunkering plan. If the difference from the least expensive alternative bunkering plan is negative (indicating that the fuel costs are lower than the fuel costs of the present bunkering plan), the ship icon corresponding to that voyage is displayed in black, and if the difference from the least expensive alternative bunkering plan is 0 or more (indicating that the fuel costs are equivalent to or more expensive than the fuel costs of the present bunkering plan), the ship icon corresponding to that voyage is displayed in white.

In bunkering plan support system 1, the fuel costs signify the cost (estimated value) of fuel to be loaded on ship 9 between now and the completion of voyage. However, in place thereof, it is also possible to use the total of the cost (established cost) of fuel already loaded on ship 9 between the start of voyage and now, and the cost (estimated value) of fuel to be loaded between now and the completion of voyage.

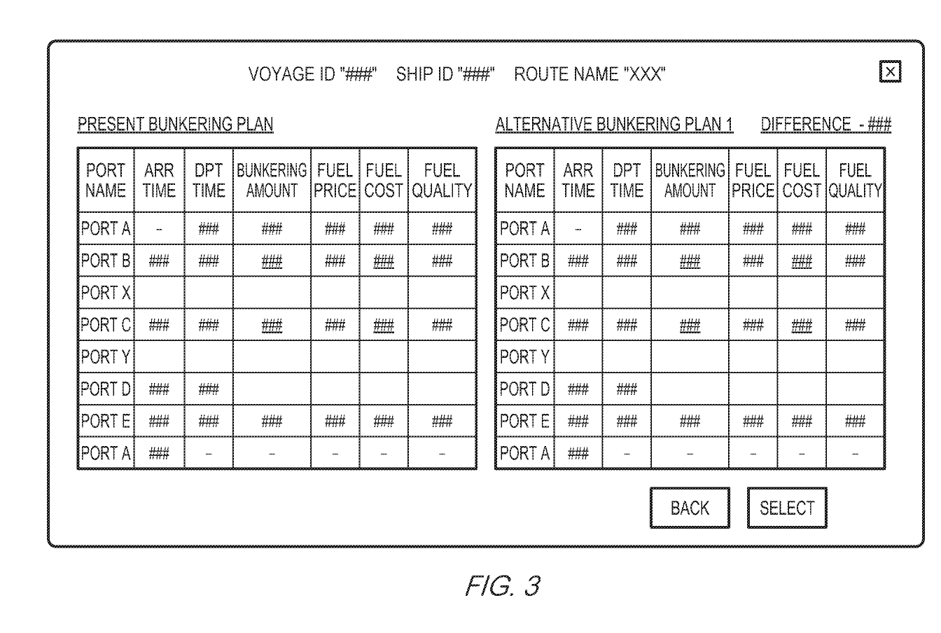

If a user double-clicks or the like on a line indicating any of the alternative bunkering plans on the list in the pop-up screen, then a detail screen as exemplified in FIG. 3 is displayed on the display of bunkering plan management server device 11 or terminal device 12. The detail screen displays details of the present bunkering plan and the alternative bunkering plan double-clicked or the like by the user. Specifically, for each of the ports of call of ship 9 (departure point, ports of call, bunkering ports and destination), the name, date and time of arrival at port, and date and time of departure from port are listed in calling order. For ports at which bunkering takes place from among these ports, bunkering amount, fuel price, fuel costs and fuel quality are displayed. On the detail screen, differences between the alternative bunkering plan and the present bunkering plan are underlined.

By clicking or the like the “select” button after selecting a line corresponding to one of the alternative bunkering plans from the list in the pop-up screen, or clicking or the like the “select” button on the details screen of one of the alternative bunkering plans, a user can set that alternative bunkering plan as a new present bunkering plan (change the present bunkering plan). If the change in the present bunkering plan results in the fuel costs of the new present bunkering plan becoming lower than the fuel costs of the new least expensive alternative bunkering plan, the ship icon corresponding to that voyage is displayed in white.

The content of information provided to users in bunkering plan support system 1 has been described above. The devices that constitute bunkering plan support system 1 are explained below.

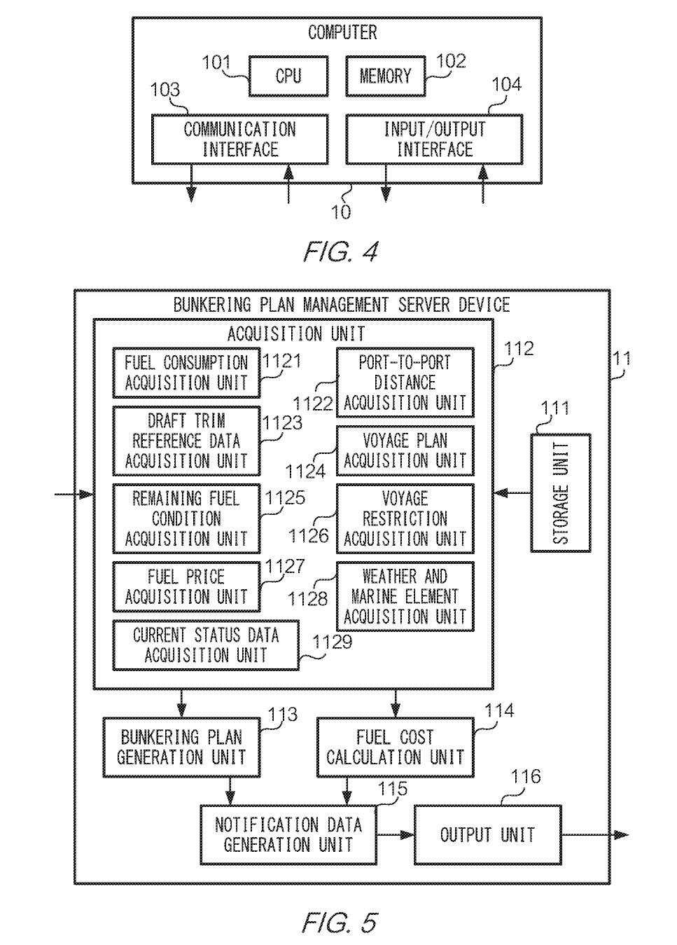

The hardware configuration of bunkering plan management server device 11, terminal device 12 and weather and marine information distribution server device 13 is a general computer provided with a communication unit that performs data communication with other devices. FIG. 4 is a drawing illustrating the configuration for computer 10 used as hardware of bunkering plan management server device 11, terminal device 12 and weather and marine information distribution server device 13.

Computer 10 is provided with a CPU 101 that performs different types of operations in accordance with a program such as an OS or an application program, and also controls other components, a memory 102 that stores the programs and different types of data, a communication interface 103 that sends and receives various types of data to and from other devices, and an input/output interface 104 that inputs and outputs various types of data to and from an operation device such as a keyboard or a mouse, a display (display device), or the like.

Ship terminal device 12-1 is provided with, as functional components, an acquisition unit that acquires data indicating an amount of fuel remaining and sailing distance measured by a group of sensors mounted on ship 9, for example, and acquiring data indicating load amount, time of arrival at port and time of departure from port input by a user such as a ship navigator, and a transmission unit that transmits data acquired by the acquisition unit to ship terminal device 12 as current status data. Ship terminal device 12 is equipped with a receiving unit that accesses bunkering plan management server device 11 using a browser function, and receives notification data (Web page data) indicating the list screen, pop-up screen and detail screen transmitted from bunkering plan management server device 11, and an output unit that outputs the content of notification data received by the receiving unit to a display or the like. That is to say, computer 10, which is the hardware of ship terminal device 12-1, functions as a device equipped with the above stated acquisition unit, transmission unit, receiving unit and output unit by executing a process in accordance with an application program for ship terminal device 12-1 as in the present embodiment.

Land-side terminal device 12-2 is provided with, as functional components, a receiving unit that accesses bunkering plan management server device 11 using a browser function, and receiving notification data (Web page data) indicating the list screen, pop-up screen and detail screen transmitted from bunkering plan management server device 11, and an output unit that outputs the content of the notification data received by the receiving unit to a display or the like. That is to say, computer 10, which is the hardware of land-side terminal device 12-2, functions as a device provided with the above stated receiving unit and output unit by executing a process in accordance with an application program for land-side terminal device 12-2 as in the present embodiment.

Weather and marine information distribution server device 13 is provided with, as functional components, a storage unit that stores weather and marine element data indicating weather and marine elements (wind speed, wind direction, wave height, etc.) in a certain sea area in current and future time ranges for a variety of combinations of time ranges and sea areas, a receiving unit that receives transmission request data that specifies a sea area and a time range from bunkering plan management server device 11, a search unit that searches for weather and marine element data corresponding to the combination of sea area and time range specified by the transmission request data received by the receiving unit, from among weather and marine element data stored by the storage unit, and a transmission unit that transmits weather and marine element data searched by the search unit to bunkering plan management server device 11, i.e. the source of the request. That is to say, computer 10, which is the hardware of weather and marine information distribution server device 13, functions as a device provided with the above stated storage unit, receiving unit, search unit and transmission unit, by executing a process in accordance with an application program for weather and marine information distribution server device 13 as in the present embodiment.

FIG. 5 is a block diagram showing the functional configuration of bunkering plan management server device 11. That is to say, computer 10, which is the hardware of the bunkering plan management server device 11, functions as a device comprising the constituent parts shown in FIG. 5, by executing processing according to the application programs for bunkering plan management server device 11 as in the present embodiment.

Bunkering plan management server device 11 is provided with, as a functional component, a storage unit 111 that stores a variety of data. Fuel consumption data port-to-port distance data, draft trim reference data, voyage plan data, remaining fuel condition data, voyage restriction data, fuel price data are stored in storage unit 111 prior to the start of voyage of ship 9.

FIG. 6 is a drawing illustrating a configuration of fuel consumption data. Fuel consumption data is provided with wind speed, wind direction, wave height, wave direction, tidal speed, tidal direction, draft, and trim, for example, as data fields for storing elements that determine the sailing conditions of ship 9. Fuel consumption data is provided with a data field for sailing speed and a data field for fuel consumption. Fuel consumption data is data specifying fuel consumption (fuel consumption amount (tons/mile) per unit sailing distance) when a voyage is performed under the sailing conditions indicated in data fields such as wind speed, and at the sailing speed in the data field of sailing speed. Fuel consumption data concerning each of a large number of ships 9 is stored by storage unit 111.

Fuel consumption data is data generated by, for example, inputting various combinations of elements (wind direction to sailing speed) to the physical simulation model (since this is a known feature, explanation thereof is omitted) of ship 9, and recording fuel consumption calculated by the computer.

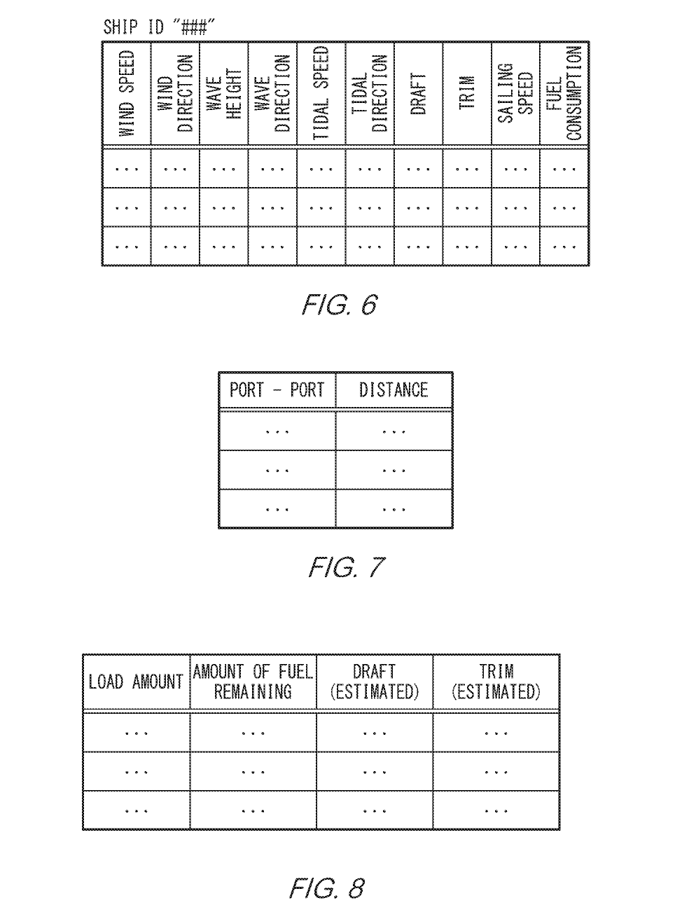

FIG. 7 is a drawing illustrating a structure of port-to-port distance data. Port-to-port distance data comprises data indicating each of various combinations of two ports (for example “A-B” indicating port A and port B) and data indicating the port-to-port distance for the combination.

FIG. 8 is a drawing illustrating a structure of draft trim reference data. Draft trim reference data is data indicating a reference value for the draft and trim of ship 9 for various combinations of load amount and amount of fuel remaining when a specific load amount has been loaded and a specific amount of fuel remaining is loaded on ship 9. Therefore, draft trim reference data for each of a large number of ships 9 is stored by storage unit 111. In the present embodiment, an estimated value for draft corresponding to a combination of load amount and amount of fuel remaining is used as the reference value for draft indicated by draft trim reference data, and a recommended value for trim corresponding to the estimated value for the draft (the trim value for optimum fuel consumption for the estimated value for draft) is used as the reference value for trim indicated by draft trim reference data. However, the reference values for draft and trim indicated by draft trim reference data are not thus limited. For example, another value such as an average value for past measured values may be used as the trim indicated by draft trim reference data. Further, draft trim reference data is not necessarily limited to data indicating reference values for draft and trim corresponding to combinations of load amount and amount of fuel remaining; it is sufficient that the data indicates the reference values for draft and trim corresponding to a loaded amount including load amount and/or amount of fuel remaining.

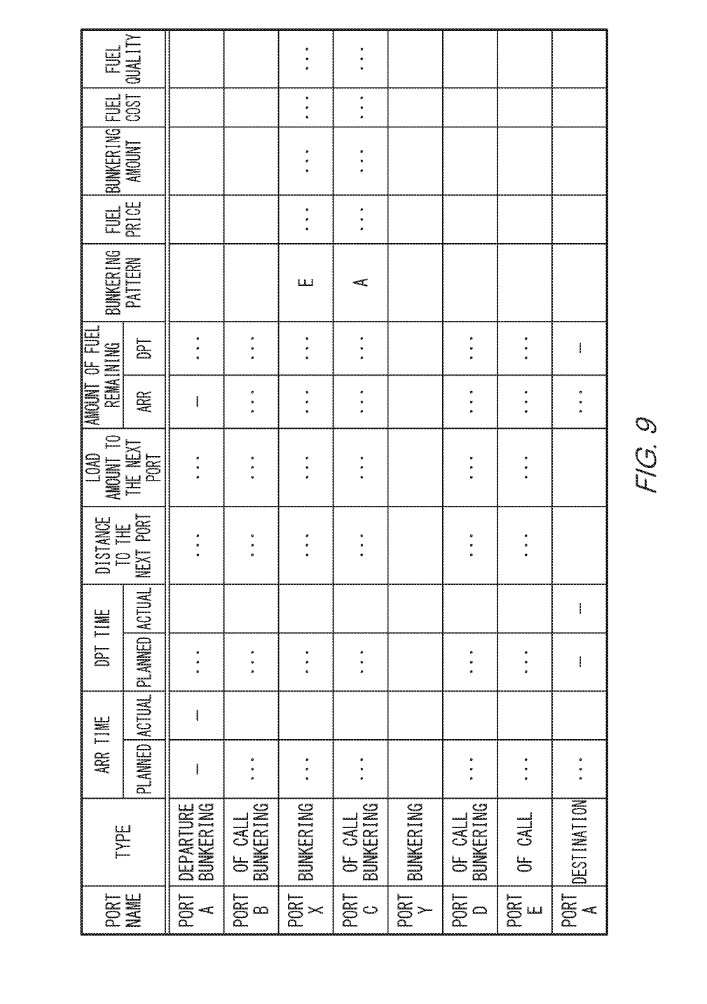

FIG. 9 is a drawing illustrating a configuration of voyage plan data. Voyage plan data for each of a large number of voyages is stored by storage unit 111. Each set of voyage plan data indicates, for each of the departure point, ports of call and destination in the voyage and each of the bunkering ports (which are not ports of call) in the vicinity of the sailing route specified by those ports, the planned and actual time of arrival at that port (excluding the departure point) and time of departure from that port (excluding the destination).

Voyage plan data includes a data field for type of port, in which is stored any of the following: “departure point”, “departure point/bunkering port”, “port of call”, “port of call/bunkering port”, “bunkering port” or “destination”. Ports for which time of arrival at port and time of departure from port are blank are bunkering ports that are not called at (that are not ports of call) or ports of call that were not called at due to port omission. Voyage plan data specifies the sailing route and voyage schedule. Hereafter, the sailing route and voyage schedule specified by voyage plan data is referred to as “voyage plan”.

Voyage plan data also includes data indicating the sailing distance and load amount for each of the port-to-port segments (sailing segment to the next port). Voyage plan data also includes data for each of the ports indicating the amount of fuel remaining when arriving at the port and when departing from the port. Further, voyage plan data includes data indicating bunkering pattern, fuel price, bunkering amount, fuel costs and fuel quality for ports classified as “departure point/bunkering port”, “port of call/bunkering port” or “bunkering port”. Bunkering patterns are data indicating an amount of fuel required to sail to a port at which bunkering is to take place. The details of fuel patterns are described below.

Ports, the type of which is “departure point/bunkering port”, “ports of call/bunkering port” or “bunkering port” are bunkering ports, but bunkering is not carried out at ports for which the data field of bunkering amount is blank. Therefore, ports that are “bunkering ports” and for which the data field of bunkering amount is blank are ports at which ship 9 does not call.

From among the data fields included in the voyage plan data, values are set by a ship operation manager, for example, for port name, type, time of arrival at port (planned) and time of departure from port (planned). The values in these data fields may be changed after the start of a voyage due to change of sailing route or the like. The values for the time of arrival at port (actual) and time of departure from port (actual) are set in accordance with current status data (described below) transmitted from ship terminal device 12-1 after the start of a voyage.

The value for the sailing distance to the next port is specified and set based on the port-to-port distance data (FIG. 7) in accordance with the settings for port name and type. If ship 9 calls at port X for bunkering, for example, the sailing distance between port B and port X is set as the value for the sailing distance to the port after port B. On the other hand, if ship 9 does not call at port X, the sailing distance between port B and port C is set as the value for the sailing distance to the next port after port B. In such a case, the data field of sailing distance to the next port of port X is blank.

The values for the amount of fuel remaining (arrival at port), amount of fuel remaining (departure from port), bunkering pattern, and bunkering amount and fuel costs is automatically set when a ship operation manager or the like opens the list screen (FIG. 2) and selects any of the alternative bunkering plans from the list on the pop-up screen, for example. The values for the fuel price and fuel quality are specified based on the fuel price data (described below, FIG. 12).

If the current bunkering plan is replaced by an alternative bunkering plan, the voyage

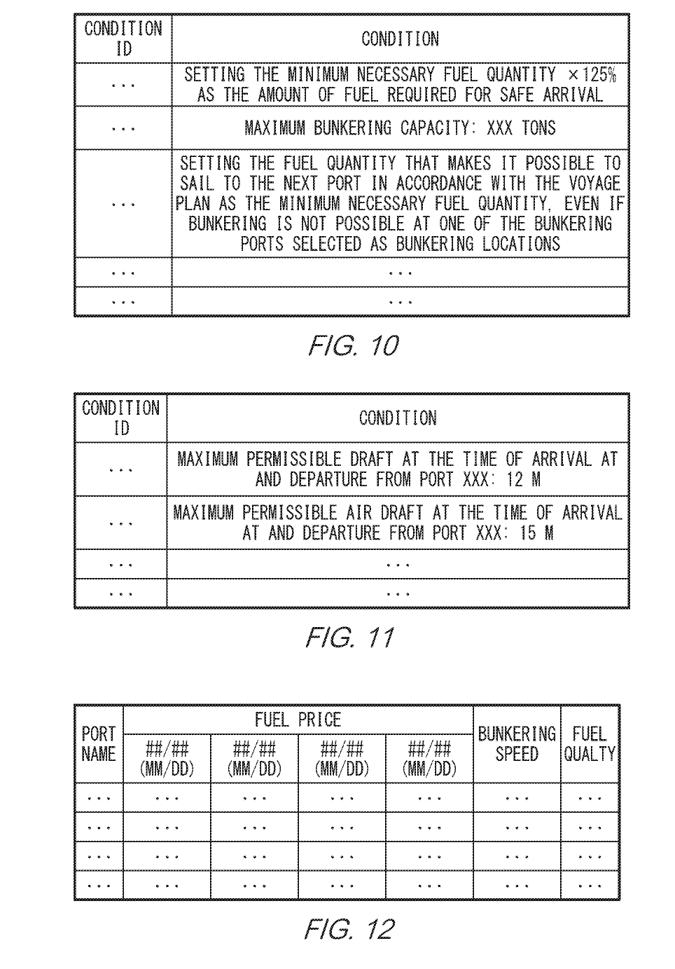

FIG. 10 is a drawing illustrating a structure of remaining fuel condition data. Remaining fuel condition data indicates various conditions relating to the amount of fuel remaining of ship 9 that should be observed when voyage is performed in accordance with the voyage plan indicated by the voyage plan data. The conditions relating to the amount of fuel remaining indicated by the remaining fuel condition data are, for example, “setting the minimum necessary fuel quantity x125% as the amount of fuel required for safe arrival”, “maximum bunkering capacity: XXX tons”, and “setting the fuel quantity that makes it possible to sail to the next port in accordance with the voyage plan as the minimum necessary fuel quantity, even if bunkering is not possible at one of the bunkering ports selected as bunkering locations”. The remaining fuel condition data for each of a large number of voyages is stored by storage unit 111. However, if the conditions applied to the voyages of the same ships 9 are the same, the remaining fuel condition data may be stored not for each voyage but for each ship 9.

FIG. 11 is a drawing illustrating a configuration of voyage restriction data. Voyage restriction data indicates various restrictions common to voyage of all of ships 9. The restrictions indicated by the voyage restriction data are, for example, “maximum permissible draft at the time of arrival at and departure from port XXX: 12 m” and “maximum permissible air draft at the time of arrival at and departure from port XXX: 15 m”.

FIG. 12 is a drawing illustrating a configuration of fuel price data. Fuel price data specifies, for each possible bunkering port, the fuel price on that day and the fuel price (estimated value) on subsequent days. Fuel price data also includes bunkering speed (ton/hour: average value, for example), data indicating fuel quality (“high quality”, “medium quality”, “low quality”, for example), minimum bunkering amount (MT), bunkering price determination date (“order date”, “bunkering date”, for example), and transaction conditions (“delivered (including barge fee)”, “ex-wharf (excluding barge fee)”, for example).

This completes explanation of each type of data stored by storage unit 111 in advance. Returning to FIG. 5, the explanation of the functional configuration of bunkering plan management server device 11 is continued below. Bunkering plan management server device 11 is provided with an acquisition unit 112 that acquires different types of data, as a functional feature. Acquisition unit 112 is provided with a fuel consumption acquisition unit 1121, a port-to-port distance acquisition unit 1122, a draft trim reference data acquisition unit 1123, a voyage plan acquisition unit 1124, a remaining fuel condition acquisition unit 1125, a voyage restriction acquisition unit 1126, and a fuel price acquisition unit 1127. Fuel consumption acquisition unit 1121 acquires, by reading from storage unit 111, fuel consumption data, port-to-port distance data, draft trim reference data, voyage plan data, remaining fuel condition data, voyage restriction data, and fuel price data.

Acquisition unit 112 is further provided with a weather and marine element acquisition unit 1128 that acquires weather and marine element data from weather and marine information distribution server device 13, and a current status data acquisition unit 1129 that acquires current status data from ship terminal device 12-1.

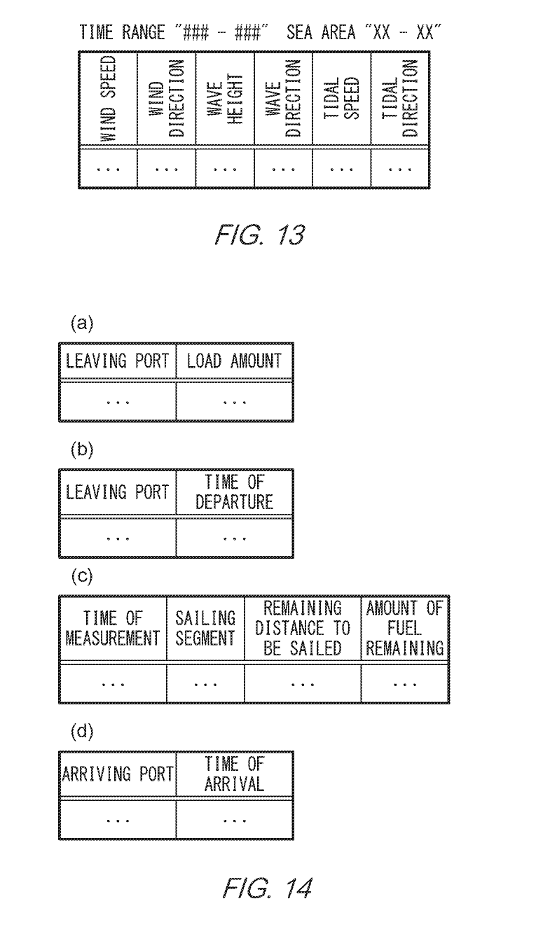

FIG. 13 is a drawing illustrating a structure of the weather and marine element data. Weather and marine element data, as mentioned previously, indicates weather and marine elements (wind speed, wind direction, wave height, etc.) in specific sea areas in specific current and future time ranges, and weather and marine information distribution server device 13 manages a database that stores weather and marine element data for various combinations of time ranges and sea areas. Weather and marine element acquisition unit 1128 transmits transmission request data specifying time range and sea area to weather and marine information distribution server device 13, and acquires weather and marine element data transmitted from weather and marine information distribution server device 13 as a response thereto. Weather and marine element data acquired by weather and marine element acquisition unit 1128 is temporarily stored by storage unit 111, and is used by a bunkering plan generation unit 113 described below to specify alternative bunkering plans.

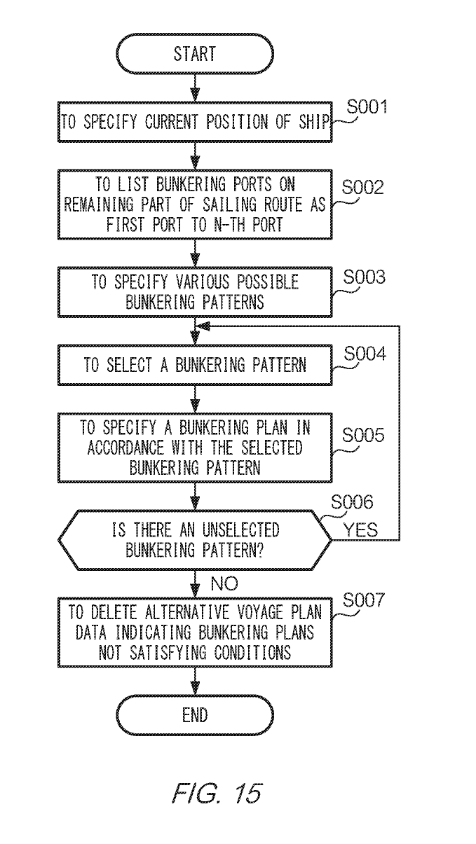

FIG. 14 is a drawing illustrating a structure of the current status data. Current status data includes data indicating the load amount when departing from each of the ports (FIG. 14 (a)), data indicating the time of departure from each of the ports (actual) (FIG. 14 (b)), data indicating the remaining distance to be sailed (miles) and amount of fuel remaining (tons) of the sailing segment (FIG. 14 (c)), and data indicating time of arrival at each of the ports (actual) (FIG. 14 (d)).

Data indicating load amount (FIG. 14 (a)) is, for example, data specified by being calculated by a ship navigator or the like when cargo handling in a port is complete, and is input to ship terminal device 12-1, and is transmitted from ship terminal device 12-1 to bunkering plan management server device 11 each time before departure from a port. Data indicating time of departure from port (FIG. 14 (b)) is data indicating time of departure from port input by a ship navigator or the like to ship terminal device 12-1, and is transmitted from ship terminal device 12-1 to bunkering plan management server device 11 on departure from each of the ports.

Data indicating the remaining distance to be sailed (miles) of the sailing segment and the amount of fuel remaining (tons) (FIG. 14 (c)) is generated based on values measured by a group of sensors mounted on ship 9, is input automatically to ship terminal device 12-1, and is transmitted from ship terminal device 12-1 to bunkering plan management server device 11 each time a predetermined time period elapses (every 30 minutes, for example) while sailing between ports (sailing segment). The remaining distance to be sailed is calculated by ship terminal device 12-1 based on the sailing distance measured by the group of sensors and the sailing distance indicated by the voyage plan data (FIG. 9) acquired by ship terminal device 12-1 from bunkering plan management server device 11.

Data indicating the time of arrival at port (FIG. 14 (d)) is data that a ship navigator or the like inputs into ship terminal device 12-1 when ship 9 arrives in port, and is transmitted from ship terminal device 12-1 to bunkering plan management server device 11 each time a ship arrives in port.

Current status data acquisition unit 1129 acquires current status data by receiving current status data transmitted from ship terminal device 12-1 at each of the timings described above. From among the current status data acquired by current status data acquisition unit 1129, current status data indicating time of departure from port (FIG. 14 (b)) and current status data indicating time of arrival at port (FIG. 14 (d)) are saved in a data field corresponding to voyage plan data (FIG. 9). As a result, voyage plan data is updated. Other current status data is temporarily stored in storage unit 111, and together with weather and marine element data, is used in the specification of an alternative bunkering plan by bunkering plan generation unit 113, which is described below.

Returning to FIG. 5 once more, the explanation of the functional configuration of bunkering plan management server device 11 is continued below. Bunkering plan management server device 11 is provided with bunkering plan generation unit 113 that specifies various alternative bunkering plans based on different types of data acquired by acquisition unit 112 (fuel consumption data port-to-port distance data, draft trim reference data, voyage plan data, remaining fuel condition data, voyage restriction data, weather and marine element data, current status data).

FIG. 15 is a drawing illustrating a specific process flow of an alternative bunkering plan performed by bunkering plan generation unit 113. When acquisition unit 112 acquires new data for any of fuel consumption data port-to-port distance data, draft trim reference data, voyage plan data, remaining fuel condition data, voyage restriction data, weather and marine element data, current status data, and the data is updated (modified), bunkering plan generation unit 113 starts the series of processes shown in FIG. 15, with the updates as a trigger.

Fuel consumption data port-to-port distance data, draft trim reference data, remaining fuel condition data, voyage restriction data are data that are modified less frequently than weather and marine element data and current status data. However, fuel consumption data and draft trim reference data are sometimes updated by corrections or the like based on data measured during an actual voyage, for example. Port-to-port distance data is sometimes updated by sailing route changes between ports, in addition to opening, closing or the like, of ports. Remaining fuel condition data is sometimes updated by a review of conditions by a ship operation manager or the like, for example. Voyage restriction data is sometimes updated in conjunction with the construction of a new bridge, the completion of dredging work or the like, for example.

On the other hand, voyage plan data, weather and marine element data, and current status data are data that are modified frequently. Each time current status data indicating time of arrival at port or time of departure from ports is newly transmitted from ship terminal device 12-1, voyage plan data is updated by the data. Voyage plan data is sometimes modified by a ship operation manager or the like when a modification to a berth window (time range during which a ship can dock at a port) occurs or when a significant delay in voyage occurs, for example.

New weather and marine element data is acquired from weather and marine information distribution server device 13 each time a predetermined time period elapses (every 30 minutes, for example). New current status data is acquired from ship terminal device 12-1, as mentioned previously, at a timing after cargo handling is complete and before departure from the departure point or ports of call for data indicating load amount (FIG. 14 (a)), when departing from the departure point, ports of call or the like for data indicating time of departure from port (FIG. 14 (b)), every time a predetermined period of time elapses (every 30 minutes, for example) for data indicating remaining distance to be sailed and amount of fuel remaining, and at the time of arrival at ports of call, the destination or the like for data indicating time of arrival at port (FIG. 14 (d)).

When any of the data is modified as described above, bunkering plan generation unit 113 first specifies the current position of ship 9 (whether ship is mooring at any of the ports or sailing any of the sailing segments) based on the time of arrival at port and time of departure from port indicated by the newest current status data (FIG. 14 (b), (d)) (step S001).

Next, bunkering plan generation unit 113 lists bunkering ports on the remaining part of the entire sailing route (bunkering ports that are ports of call) or bunkering ports in the vicinity of the remaining part (bunkering ports that are not ports of call) based on the voyage plan data as first port to nth port in accordance with the order in the direction of sail (step S002).

Next, bunkering plan generation unit 113 generates various patterns for the bunkering plan (hereafter referred to as “bunkering pattern”) for the listed first port to nth port, as bunkering, at the ith port (i is an arbitrary natural number where 1≦i≦n), until the amount of fuel required for safe arrival at (i+1)th port is reached, until the amount of fuel required for safe arrival at (i+2)th port is reached, . . . , until the amount of fuel required for safe arrival at the nth port is reached, until the amount of fuel required for safe arrival at the destination is reached, etc.

The specific details of steps S002 and S003 are explained using a case in which ship 9 is currently, as indicated in FIG. 1, being sailed in a position before port X in the sailing segment between port B and port C as an example. In this case, in the process of step S002, bunkering plan generation unit 113 lists a total of four ports (n=4): port X (first port), port C (second port), port Y (third port) and port E (fourth port).

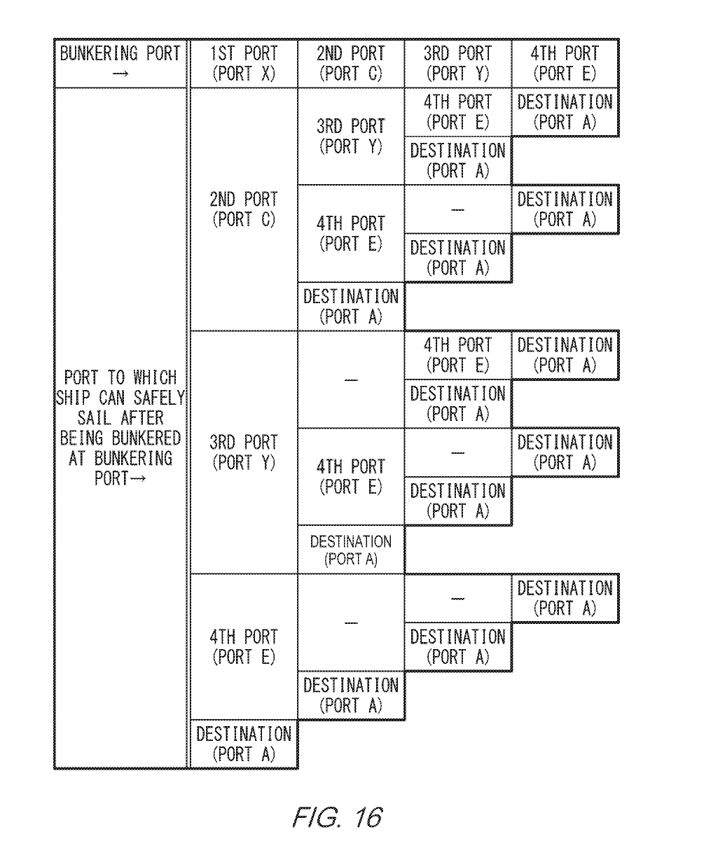

Next, bunkering plan generation unit 113 specifies various possible bunkering patterns in the process of step S003 by generating a table such as the table shown in FIG. 16, for example, in accordance with a predetermined algorithm. The table in FIG. 16 shows bunkering until the amount of fuel required for safe arrival, at the bunkering port shown on the first line, for sailing to the port indicated below the bunkering port. The amount of fuel required for safe arrival is the amount of fuel required for safe arrival stipulated in the remaining fuel condition data (FIG. 10).

Firstly, to generate the table in FIG. 16, bunkering plan generation unit 113 lists, as options of bunkering amounts that may be adopted in the first port (port X), an option of ensuring the amount of fuel required for safe arrival at the second port (port C), an option of ensuring the amount of fuel required for safe arrival at the third port (port Y), an option of ensuring the amount of fuel required for safe arrival at the fourth port (port E), and an option of ensuring the amount of fuel required for safe arrival at the destination (port A), in the first port (port X) column.

Next, bunkering plan generation unit 113 lists, for each of the options for bunkering amounts at the first port (port X) listed as described above, options of bunkering amounts that may be adopted at the second port (port C) when the option is selected, in the second port (port C) column.

For example, if the option to ensure that an amount of fuel required for safe arrival to the second port (port C) is selected at the first port (port X), bunkering must be performed at the second port (port C). The options for bunkering amounts that may be adopted at the second port (port C) are an option of ensuring the amount of fuel required for arrival at the third port (port Y), an option of ensuring the amount of fuel required for arrival at the fourth port (port E), and an option of securing the amount of fuel required for arrival at the destination (port A). Bunkering plan generation unit 113 lists the options.

Meanwhile, at the first port (port X), if the option to ensure the amount of fuel required for safe arrival at the third port (port Y) is selected, at the second port (port C), the amount of fuel required for safe arrival to the third port (port Y) is already ensured, so there is an option to omit carrying out bunkering. Therefore, bunkering plan generation unit 113 lists an option of not bunkering, an option of ensuring the amount of fuel required for arrival at the fourth port (port E), and an option of ensuring the amount of fuel required for safe arrival at the destination (port A).

By generating the list of FIG. 16 in accordance with rules such as the rules described above, bunkering plan generation unit 113 specifies a total of 14 bunkering patterns indicated by OP01 to OP14 below. However, in the below representation, [X/C] indicates bunkering, at port X, until the amount of fuel required for safe arrival for sailing to port C is reached, for example, and [Y/−] indicates not bunkering at port Y.

OP01:[X/C][C/Y][Y/E][E/A]

OP02:[X/C][C/Y][Y/A]

OP03:[X/C][C/E][Y/−][E/A]

OP04:[X/C][C/E][Y/A]

OP05:[X/C][C/A]

OP06:[X/Y][C/−][Y/E][E/A]

OP07:[X/Y][C/−][Y/A]

OP08:[X/Y][C/E][Y/−][E/A]

OP09:[X/Y][C/E][Y/A]

OP10:[X/Y][C/A]

OP11: [X/E][C/−][Y/−][E/A]

OP12:[X/E][C/−][Y/A]

OP13:[X/E][C/A]

OP14:[X/A]

Next, bunkering plan generation unit 113 selects the first bunkering pattern specified in step S003 as a bunkering pattern that serves as a specific target of the bunkering amount (step S004). Next, bunkering plan generation unit 113 performs a specific process of the bunkering plan according to the bunkering pattern selected in step S004 (step S005).

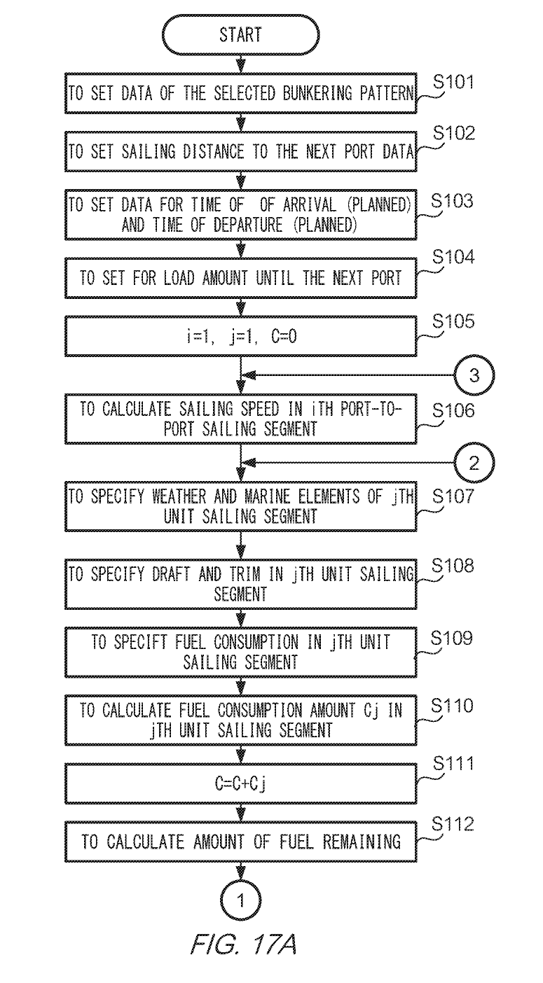

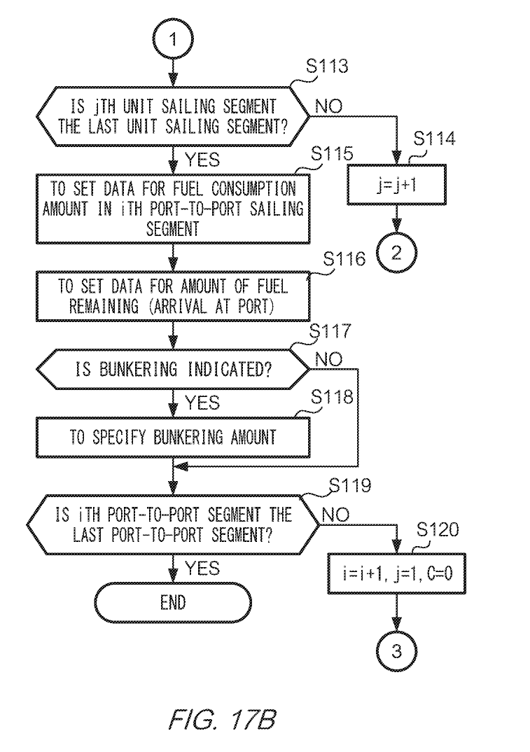

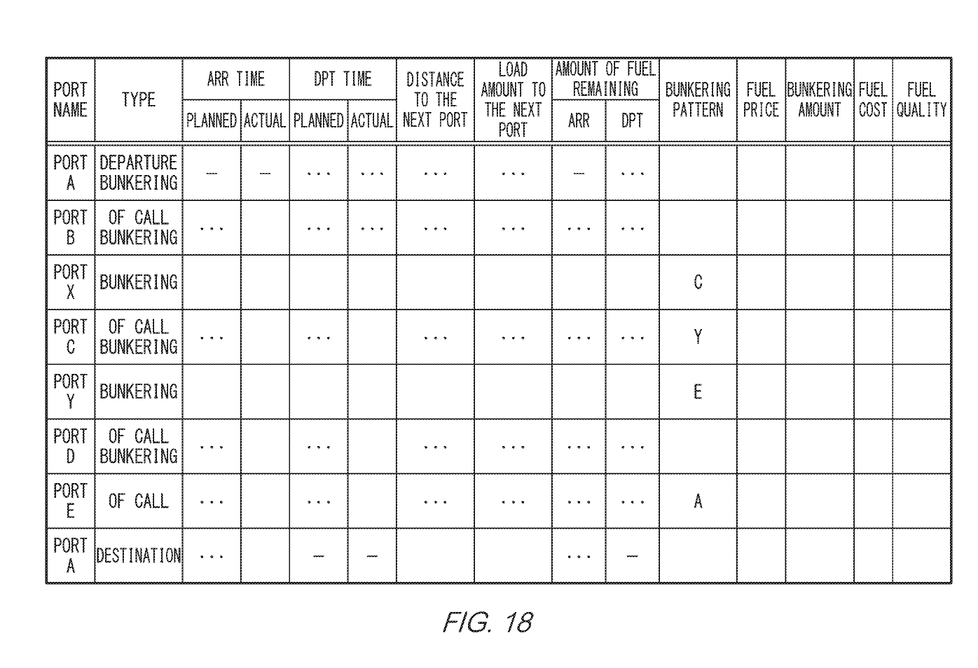

FIG. 17A and FIG. 17B (hereafter collectively referred to as “FIG. 17”) are flow diagrams indicating the details of the process in step S005. In the process in step S005, firstly, bunkering plan generation unit 113 generates a duplicate of the voyage plan data (FIG. 9) as alternative voyage plan data, and sets the data according to the bunkering pattern selected in step S004 in the “bunkering pattern” of the generated alternative voyage plan data (step S101). FIG. 18 is a drawing illustrating the configuration of the alternative voyage plan data in the state in which the data according to the first bunkering pattern shown in FIG. 16 is set in the “bunkering pattern”.

Next, in accordance with “bunkering pattern” data, bunkering plan generation unit 113 sets or updates sailing distance to the next port data based on port-to-port distance data (step S102). When following the first bunkering pattern, since the ship calls at port X and port Y, bunkering ports that are not ports of call, data is newly set in the “sailing distance to the next port” of port X and port Y, while the data in the “sailing distance to the next port” of port B and port C is updated.

Next, bunkering plan generation unit 113, when the data of the “bunkering pattern” shows calling at bunkering ports that are not ports of call, sets the data for “time of arrival at port (planned)” and “time of departure from port (planned)” for those bunkering ports (step S103). When following the first bunkering pattern, since the ship calls at port X and port Y, which are ports of call, bunkering plan generation unit 113 newly sets data for “time of arrival at port (planned)” and “time of departure from port (planned)”. Specifically, bunkering plan generation unit 113 temporarily sets the mooring time at port X as a predetermined value (2 hours, for example), and determines the time of arrival at port (planned) and time of departure from port (planned) for port X so as to divide the time in which mooring time at port X (2 hours, for example) is deducted from the time taken from the time of departure from port B (planned) to the time of arrival at port C (planned) by a ratio corresponding to the sailing distance between port B and port X and the sailing distance between port X and port C. Bunkering plan generation unit 113 sets data determined as such as the “time of arrival at port (planned)” and “time of departure from port (planned)” for port X. The same is the case for port Y. Thereby, a voyage schedule according to a bunkering pattern is set as alternative voyage plan data.

Next, bunkering plan generation unit 113, when the data of the “bunkering pattern” shows calling at bunkering ports that are not ports of call, sets the data for “load amount until the next port” for those bunkering ports (step S104). When following the first bunkering pattern, since the ship calls at port X and port Y, which are bunkering ports that are not ports of call, bunkering plan generation unit 113 copies the “load amount to the next port” data of port B to the “load amount to the next port” of port X, and copies the “load amount to the next port” data of port C to the “load amount to the next port” of port Y to set these data.

Next, bunkering plan generation unit 113 begins a series of processes that specify the data for “bunkering amount”. To do this, firstly, bunkering plan generation unit 113 substitutes a variable “i” indicating the order of the sailing segments between ports and a variable “j” indicating the order of segments in which each of the sailing segments is divided into segments with a predetermined distance (1 mile, for example) with a default value “1”, and substitutes a variable “C” for storing the accumulated values for the fuel consumption amount (estimated value) within the sailing segments between ports with a default value “0” (step S105). Hereafter, the sailing segments between ports are referred to as “port-to-port sailing segments” and the segments in which the sailing segments are divided into segments with a predetermined distance are referred to as “unit sailing segments”.

Next, bunkering plan generation unit 113 calculates the sailing speed in an ith port-to-port sailing segment (step S106). If i=1, bunkering plan generation unit 113 calculates the sailing speed for a first port-to-port sailing segment as described below. That is to say, bunkering plan generation unit 113 specifies the time between the current time and the time indicated by the “time of arrival at port (planned)” of the port that is the final destination of the first port-to-port sailing segment (in this case, port X) as the sailing time of the first port-to-port sailing segment (in this case, the segment between the current point and port X). Bunkering plan generation unit 113 specifies the sailing distance of the first port-to-port sailing segment from the value for the “remaining distance to be sailed within the sailing segment” indicated by the latest current status data (FIG. 13(c)) that indicates the remaining distance to be sailed transmitted from ship terminal device 12. Bunkering plan generation unit 113 calculates the sailing speed of the first port-to-port sailing segment by dividing the sailing distance specified as such by the sailing time.

If i≧2, bunkering plan generation unit 113 calculates the sailing speed of an ith port-to-port sailing segment as described below. That is to say, bunkering plan generation unit 113 specifies the time between the time indicated by the “time of departure from port (planned)” of the departure port of the ith port-to-port sailing segment and the time indicated by the “time of arrival at port (planned)” of the final destination the ith port-to-port sailing segment as the sailing time of the ith port-to-port sailing segment. Bunkering plan generation unit 113 specifies the sailing distance of the ith port-to-port sailing segment from the value for the “sailing distance to the next port” of the departure port of the ith port-to-port sailing segment. Bunkering plan generation unit 113 calculates the sailing speed of the ith port-to-port sailing segment by dividing the sailing distance specified as such by the sailing time.

Next, bunkering plan generation unit 113 specifies weather and marine condition elements (wind speed, wind direction, wave height, etc.) predicted to be encountered by ship 9 during a sail of the jth unit sailing segment of the ith port-to-port sailing segment (hereafter simply referred to as “jth unit sailing segment”) based on the most recent weather and marine element data acquired from weather and marine information distribution server device 13 (step S107).

Weather and marine element data is provided per sea area and per time range. Therefore, bunkering plan generation unit 113 specifies the weather and marine condition elements (wind speed, wind direction, wave height, etc.) of the jth unit sailing segment from weather and marine element data corresponding to the sea area to which the ith port-to-port sailing segment belongs, and weather and marine element data corresponding to the time range in which ship 9 sails the jth unit sailing segment.

If i=1 and j=1, the sailing time range of the first unit sailing segment of the first port-to-port sailing segment is specified as the time range between the current time and a time after the current time, by which latter time the sailing distance of the unit sailing segment is divided by the sailing speed specified in step S106. Each of the sailing time ranges of other unit sailing segments is specified as a time range between the end time of the prior unit sailing segment and a time after this, by which latter time the sailing distance of the unit sailing segment is divided by the sailing speed specified in step S106.

Next, bunkering plan generation unit 113 specifies the draft (estimated value) and trim (recommended value) when ship 9 sails the jth unit sailing segment in accordance with the draft trim reference data (FIG. 8) (step S108). To specify the draft and trim in accordance with the draft trim reference data, it is necessary to specify load amount and amount of fuel remaining. Firstly, with regard to load amount, the value for “load amount to the next port” of the departure port of the ith port-to-port sailing segment is used for all of the unit sailing segments within the ith port-to-port sailing segment.

With regard to amount of fuel remaining, the values used in the first unit sailing segment (if i=1 and j=1) and the values used in the other unit sailing segments differ. Firstly, for the first unit sailing segment of the first port-to-port sailing segment, the amount of fuel remaining indicated by the newest current status data (FIG. 14(c)) indicating the amount of fuel remaining transmitted from ship terminal device 12-1 is used. For the unit sailing segments other than the first port-to-port sailing segment, the amount of fuel remaining calculated for the previous unit sailing segment in step S112, described below, is used.

Next, bunkering plan generation unit 113 specifies fuel consumption corresponding to a combination of the fuel consumption data (FIG. 6), the sailing speed specified in step S106, the weather/marine elements (wind speed, wind direction, wave height, etc.) specified in step S107, and the draft and trim specified in step S108, as fuel consumption when ship 9 sails the jth unit sailing segment (step S109).

Next, bunkering plan generation unit 113 calculates the fuel consumption amount when ship 9 sails a jth unit sailing segment, by multiplying the distance of the unit sailing segment by the fuel consumption specified in step S109 (step S110). Hereafter, the value for the fuel consumption amount calculated in step S110 is defined as Cj.

Next, bunkering plan generation unit 113 adds the fuel consumption amount “Cj” calculated in S110 to the cumulative fuel consumption amount “C”, thereby updating the cumulative fuel consumption amount “C” (step S111).

Next, bunkering plan generation unit 113 subtracts the fuel consumption amount “Cj” calculated in step S110 from the amount of fuel remaining at the point when ship 9 started a sail of the jth unit sailing segment, i.e. the amount of fuel remaining used to specify the draft and trim in step S108, to calculate the amount of fuel remaining at the point when ship 9 completes the sail of the jth unit sailing segment (step S112).

Next, bunkering plan generation unit 113 determines whether or not the jth unit sailing segment is the last unit sailing segment included in the ith port-to-port sailing segment (step S113). If the jth unit sailing segment is not the last unit sailing segment included in the ith port-to-port sailing segment (step S113 No), bunkering plan generation unit 113 variably adds “1” to “j” (step S114), and repeats the processes after step S107 described above for a new jth unit sailing segment.

If the jth unit sailing segment is the last unit sailing segment included in the ith port-to-port sailing segment (step S113 Yes), bunkering plan generation unit 113 temporarily stores, in storage unit 111, the cumulative fuel consumption amount “C” as the fuel consumption amount when ship 9 sails an ith port-to-port sailing segment (step S115).

Next, bunkering plan generation unit 113 sets the value for the amount of fuel remaining calculated in the previous step S112 in the “amount of fuel remaining (arrival at port)” of the destination port of the ith port-to-port sailing segment (step S116). Next, bunkering plan generation unit 113 determines whether or not the “bunkering pattern” of the destination port of the ith port-to-port sailing segment indicates bunkering at the port (step S117).

If bunkering at the destination port of the ith port-to-port sailing segment is indicated (step S117 Yes), bunkering plan generation unit 113 performs a process (described below) of specifying the bunkering amount at the port, and sets the specified bunkering amount as the “bunkering amount” at the port (step S118).

Bunkering plan generation unit 113 does not carry out step S118 if it is determined in step S117 that bunkering at the destination port of the ith port-to-port sailing segment is not indicated (step S117 No), and determines whether or not the ith port-to-port sailing segment is the last port-to-port sailing segment after completion of step S118 if it is determined in step S117 that bunkering at the destination port of the ith port-to-port sailing segment is indicated (step S117 Yes) (step S119).

If the ith port-to-port sailing segment is not the last port-to-port sailing segment (step S119 No), bunkering plan generation unit 113 formats the variables by adding “1” to variable “I”, replacing variable “j” with “1”, and replacing variable “C” with “0” (step S120). Then, bunkering plan generation unit 113 repeats the processes after step S106 described above for a new ith port-to-port sailing segment. If the ith port-to-port sailing segment is the last port-to-port sailing segment (step S119 Yes), bunkering plan generation unit 113 completes step S005 in FIG. 5.

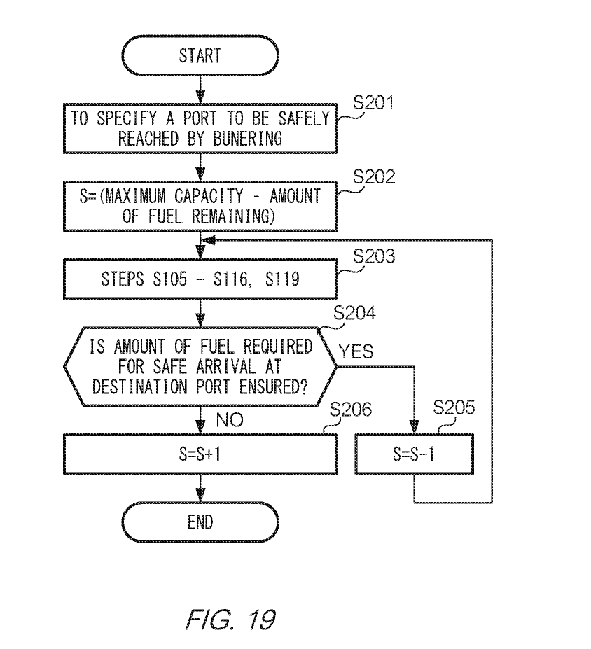

FIG. 19 is a flowchart showing details of the process of step S118 shown in FIG. 17. In the process of step S118, firstly, bunkering plan generation unit 113 specifies an amount of fuel required for arrival at a particular port. A port to be reached, for which this fuel quantity is required, is determined for the port at which the loading amount is to be specified (hereafter referred to as “port in question”) from the pattern data for the port (step S201). Hereafter, the port specified in step S201 is referred to as “port of destination”.

Next, bunkering plan generation unit 113 replaces variable “S” indicating the provisional bunkering amount at the port in question with a value in which the amount of fuel remaining calculated in the previous step 112 (FIG. 17) is deducted from the maximum capacity of the fuel tank of ship 9 as a default value (step S202).

Next, bunkering plan generation unit 113 performs processes similar to steps S105-S116 and S119 (FIG. 17) for one or more of the port-to-port segment sailing routes between the port in question and the port of destination (step S203).

Next, bunkering plan generation unit 113 determines whether or not an amount of fuel required for safe arrival at the port of destination is ensured at the port in question from the provisional bunkering amount indicated by variable “S” based on the sum of the amount of fuel remaining calculated in step S112 carried out last within step S203, and the fuel consumption amount of each of the port-to-port sailing segments temporarily stored by storage unit 111 in step S115 within step S203 (step S204). For example, if the amount of fuel required for safe arrival is the minimum necessary fuel quantity×125%, bunkering plan generation unit 113 determines that an amount of fuel required for safe arrival at the port of destination is ensured at the port in question if the amount of fuel remaining (amount of fuel remaining at the time of arrival at port of destination) calculated in step S112 carried out last within step S203 is 25% or more of the sum of the fuel consumption amounts of each of the port-to-port sailing segments temporarily stored by storage unit 111 in step S115 within step S203 (step S204 Yes), and determines that an amount of fuel required for safe arrival at the port of destination is not ensured at the port in question if the amount of fuel remaining is less than 25% of the sum of the fuel consumption amounts (step S204 No).

In step S204, if it is determined that an amount of fuel required for arrival at the port of destination is ensured at the port in question (step S204 Yes), bunkering plan generation unit 113 deducts “1” from variable “S” indicating a provisional bunkering amount (step S205) and repeats the process after step S203. On the other hand, if in step S204 the amount of fuel required for arrival at the port of destination is deemed to be ensured for the port in question (step S204; No), bunkering plan generation unit 113 adds “1” to the variable “S” indicating the provisional bunkering amount (step S206).

The value for the variable “S” calculated in step S206 indicates the minimum fuel quantity that should be taken on at the port in question to ensure the amount of fuel required for arrival at the port of destination. Therefore, bunkering plan generation unit 113 specifies the value for variable “S” calculated in step S206 as the bunkering amount at the port in question, and sets this value in the “bunkering amount” data field of the alternative voyage plan data (FIG. 18). Thereby, step S118 in FIG. 17 is complete.

Once the bunkering plan is specified for the bunkering pattern selected in step S004 in FIG. 15 by the series of processes described above with reference to FIG. 17 and FIG. 19 (step S005), bunkering plan generation unit 113 determines whether or not there is a bunkering pattern that has not been selected in step S004 from among the bunkering patterns that were specified in step S003 (step S006).

If there is a bunkering pattern that has not been selected (step S006; Yes), bunkering plan generation unit 113 returns to step S004, and after a bunkering pattern that has not been selected from the bunkering patterns specified in step S003 is selected anew, the process of step S005 and subsequent steps is repeated.

If there is no bunkering pattern that has not been selected (step S006; No), bunkering plan generation unit 113 determines whether or not the bunkering plan specified in S005 satisfies the conditions indicated in the remaining fuel condition data (FIG. 10) and voyage restriction data (FIG. 11), and deletes the alternative voyage plan data indicating bunkering plans that do not satisfy at least some of the conditions (step S007).

The alternative voyage plan data generated by bunkering plan generation unit 113 as described above is data indicating an alternative bunkering plan.

Returning to FIG. 5, the explanation of the functional configuration of the bunkering plan management server device 11 is continued below. Bunkering plan management server device 11 is provided with a fuel cost calculation unit 114 that calculates fuel costs required if bunkering is carried out in accordance with each of the alternative bunkering plans, based on fuel price data (FIG. 12) and alternative voyage plan data generated by bunkering plan generation unit 113, as described above.

Fuel cost calculation unit 114 specifies fuel price and fuel quality in accordance with the fuel price data (FIG. 12) for each of the ports for which a value is set for the “bunkering amount” of the alternative voyage plan data, and sets the fuel price and fuel quality in the corresponding data fields of the alternative voyage plan data. Next, fuel cost calculation unit 114 calculates fuel costs by multiplying the fuel price set as such by bunkering amount, and sets this in the “fuel costs” data field. Thereby, the alternative voyage plan data indicates an alternative bunkering plan and the fuel costs incurred by following that alternative bunkering plan.

When new fuel price data is acquired by acquisition unit 112, fuel cost calculation unit 114 updates the alternative voyage plan data by recalculating the fuel costs using the new fuel price data, and setting the newly calculated fuel costs in the “fuel costs” data field.

In addition to generating and updating the alternative voyage plan data described above, bunkering plan generation unit 113 and fuel cost calculation unit 114 updates the voyage plan data (FIG. 9).

Specifically, if new data is acquired by acquisition unit 112 for any of fuel consumption data port-to-port distance data, draft trim reference data, voyage plan data, remaining fuel condition data, voyage restriction data, weather and marine element data, and current status data, and the data is updated (modified), bunkering plan generation unit 113 updates the voyage plan data by carrying out a process similar to step S005 in FIG. 15 on the voyage plan data using the update as a trigger.

If voyage plan data is updated by bunkering plan generation unit 113 or if new fuel price data is acquired by acquisition unit 112, fuel cost calculation unit 114 updates the voyage plan data by recalculating resetting the fuel costs indicated by the voyage plan data.

Bunkering plan management server device 11 is provided with a notification data generation unit 115 that generates notification data that shows a list screen (FIG. 2), pop-up screen (FIG. 2) and detail screen (FIG. 3) in accordance with voyage plan data and alternative voyage plan data generated and updated by bunkering plan generation unit 113 and fuel cost calculation unit 114 as described above. Notification data generation unit 115 generates notification data that shows a list screen by setting data such as current position specified based on current status data (data indicating remaining distance to be sailed) transmitted from ship terminal device 12-1 corresponding to each of a plurality of ships 9 or fuel price at each of the bunkering ports indicated by fuel price data in the pattern data on the list screen stored by storage unit 111 in advance.

Notification data generation unit 115 sorts the alternative voyage plan data for each of ships 9 in ascending order or the total fuel costs indicated thereby, and then selects the top three. Notification data generation unit 115 generates notification data showing a pop-up screen by setting the total fuel costs indicated by the selected alternative voyage plan data and the total fuel costs indicated by the voyage plan data (FIG. 9) in the pattern data on the pop-up screen stored by storage unit 111 in advance.

For a voyage in which the fuel costs (total amount) of the first alternative bunkering plan are lower than the fuel costs (total amount) of the present bunkering plan indicated by the notification data of the generated pop-up screen, notification data generation unit 115 updates the notification data on the list screen so as to display ship icons indicating ship 9 corresponding to that voyage in the notification data on the list screen in black, and other ship icons in white.

If either voyage plan data or alternative voyage plan data is updated for each of ships 9, notification data generation unit 115 updates the notification data on the list screen and pop-up screen using the updated data.

If, for example, any of the alternative bunkering plans in the list on the pop-up screen is clicked or the like by a user, notification data generation unit 115 generates notification data showing a detail screen by setting the value in each of the data fields of corresponding alternative voyage plan data and voyage plan data in the pattern data on the detail screen stored by storage unit 111 in advance.

Notification data indicating each of the list screen, pop-up screen and detail screen generated by notification data generation unit 115 is output by an output unit 116 on a display connected to bunkering plan management server device 11, and is transmitted to the network in accordance with a request from terminal device 12. As a result, users are presented with different types of information concerning the bunkering plan, as shown in FIG. 2 and FIG. 3.

As described above, bunkering plan support system 1 allows a user to maintain an amount of fuel remaining sufficient to reach a subsequent port while easily knowing bunkering ports and bunkering amount for which fuel costs are low when a ship sails a sailing route according to a voyage plan.

### Modified Examples

The embodiment described above may be modified into various embodiments within the scope of the technical idea of the present invention. Examples of these modifications are shown below.

(1) In the embodiment described above, fuel consumption data is set as data generated using a physical simulation model of ship 9, but the method for generating fuel consumption data is not limited thereto. For example, the data may be data generated by amending data generated by statistically processing the parameters and fuel consumptions actually measured in past voyages of ship 9 or data generated using a physical simulation model or the like, with data obtained by statistically processing the parameters and fuel consumptions actually measured in past voyages of ship 9, or the like.

(2) In the embodiment described above, fuel consumption data is set to be data in table format as illustrated in FIG. 6, but may be, for example, any data that indicates fuel consumption corresponding to combinations of various parameters relating to sailing conditions, such as data that indicates a function formula that calculates fuel consumption in which the values for wind speed and sailing speed are set as variables.

(3) In the embodiment described above, data fields such as wind speed, wind direction, wave height, etc. are provided in the fuel consumption data (FIG. 6) and weather and marine element data (FIG. 13), but these data fields can be arbitrarily changed by, for example, adding wave period. A configuration may be adopted in which parameters such as ship hull fouling or propeller fouling that affect the fuel consumption of ship 9, unrelated to weather and marine conditions, are provided as data fields. Weather and marine elements are not always necessary. If parameters related to weather and marine conditions are not used, weather and marine information distribution server device 13 becomes unnecessary.

(4) In the embodiment described above, each port-to-port sailing routes is set as one sailing segment, and sailing time, sailing distance, sailing speed, fuel consumption and the like are calculated for the sailing segment. In place thereof, a configuration may be adopted in which the port-to-port sailing routes are divided into a plurality of sailing segments, and sailing time, sailing distance, sailing speed, fuel consumption and the like are calculated for each of the plurality of divided sailing segments. For example, if weather and marine element data is not provided for one sea area that covers a port-to-port sailing segment but is provided for each of smaller sea areas, fuel consumption is specified for each sailing segment corresponding to those sea areas, and if fuel consumption amount is calculated, calculation of more precise fuel costs becomes possible.

(5) In the explanation of the embodiment described above, there is no particular mention of whether the sailing speed is speed over ground or speed through water. The sailing speed may be speed over ground or speed through water. In the embodiment described above, fuel consumption is set to be the fuel consumption amount per unit sailing distance (ton/mile), but fuel consumption amount per unit time (ton/day) may be used as the fuel consumption.

(6) In the embodiment described above, data such as fuel consumption data and port-to-port distance data are stored in bunkering plan management server device 11 in advance, but in place thereof, a configuration in which data is stored either directly in bunkering plan management server device 11 or in a storage device connected via a network is acquired and used by acquisition unit 112 may be adopted.

(7) In the embodiment described above, bunkering plan management server device 11 is configured as a device that is different from ship terminal device 12-1, but a configuration in which bunkering plan management server device 11 is integrated with ship terminal device 12-1 to be one device may be adopted. In such a case, the processes carried out by bunkering plan management server device 11 described above are carried out by ship terminal device 12-1 mounted on ship 9. In the embodiment described above, weather and marine information distribution server device 13 is configured as a device that is different from bunkering plan management server device 11, but a configuration in which weather and marine information distribution server device 13 is integrated with bunkering plan management server device 11 to be one device may be adopted.

(8) In the embodiment described above, during voyage of a ship, the current position of the ship is specified based on sailing distance (or remaining distance to be sailed calculated on the basis thereof) and port-to-port sailing distance on the sailing route indicated by the voyage plan data, but the method for specifying the current position of the ship is not limited thereto. For example, if ship 9 is provided with a GPS, a configuration may be adopted in which the current position of the ship is specified based on position data indicating a combination of a latitude and a longitude of ship 9 is transmitted from ship terminal device 12-1 to bunkering plan management server device 11 as current status data and received by bunkering plan management server device 11. Further, a configuration may be adopted in which a ship navigator or the like manually inputs the remaining distance to be sailed of the sailing segment currently being sailed to ship terminal device 12-1, and the manually input data indicating the remaining distance to be sailed is transmitted to bunkering plan management server device 11 as current status data.

(9) Sailing route R exemplified in the embodiment described above is a so-called round-trip sailing route in which the departure port and destination port are the same port (port A), but sailing routes for which the bunkering plan is managed by bunkering plan support system 1 are not limited to round-trip sailing routes.

(10) In the embodiment described above, a configuration in which bunkering plan management server device 11 specifies all possible bunkering patterns and calculates the fuel costs for all of those bunkering patterns is adopted. In place thereof, a configuration in which, for example, fuel costs are calculated only for bunkering plans in which there is a high possibility that the fuel costs are low may be adopted. As an example of such a calculation method, a method of specifying a bunkering pattern so as to prioritize bunkering at bunkering ports with low fuel prices, where the ship is bunkered to its maximum bunkering capacity (or the amount of fuel required to ensure arrival at the destination) at the bunkering port with the lowest fuel price from among the bunkering ports on the entire sailing route, and subsequently the ship is bunkered to its maximum bunkering capacity (or the amount of fuel required for safe arrival at the destination) at the bunkering port with the lowest fuel price from among the bunkering ports on the route segment in which there is a fuel shortage on the sailing route, etc. can be considered.

(11) In the embodiment described above, the bunkering plan is limited so as to satisfy conditions related to the amount of fuel remaining indicated by the remaining fuel condition data and conditions related to limits such as maximum draft indicated by the voyage restriction data. Conditions for limiting the bunkering plan are not limited to conditions of these types, and various types of conditions may be adopted. For example, if a monthly minimum bunkering amount is determined by a contract between a ship operation manager and a fuel supplier at a specific bunkering port, an artificially determined condition of setting the bunkering amount at that bunkering port to the maximum amount until the minimum bunkering amount is exceeded may be adopted.

(12) In the embodiment described above, a configuration in which, if an alternative bunkering plan with fuel costs that are even slightly lower than the fuel costs when following the present bunkering plan is introduced, the notification data generated by notification data generation unit 115 constantly notifies a user of this through a change in display mode of the icons is adopted. In place thereof, a configuration in which a user is notified only if an alternative bunkering plan with fuel costs in which the cost is reduced by at least a predetermined threshold value compared to the fuel costs when following the present bunkering plan, for example, may be adopted.

(13) In the embodiment described above, data presented as an alternative bunkering plan equally satisfies conditions indicated by remaining fuel condition data or voyage restriction data, but a configuration in which, for example, an alternative bunkering plan that minimizes fuel costs under conditions in which port omission risk is taken into account is compared to an alternative bunkering plan that minimizes fuel costs under conditions in which port omission risk is not taken into account and displayed or the like may be adopted.

(14) In the embodiment described above, attention is paid only to fuel costs, but a configuration in which costs other than fuel costs such as port charges or labour costs are also combined to calculate the cost, and a bunkering plan that is desirable based on the total cost is displayed may be adopted.

(15) In the embodiment described above, the price on the day of browsing is displayed as the fuel price displayed to a user. In place thereof, or in addition thereto, a configuration in which the fuel price (projected price, estimated price or the like) on the bunkering price determination date (for example, “order date” or “bunkering date”) is displayed to a user may be adopted.

(16) In the embodiment described above, the fuel costs in the alternative bunkering plan are calculated using the current fuel price. In place thereof, a configuration in which fuel costs in the alternative bunkering plan are calculated using the fuel price (planned price, estimated price or the like) on the bunkering price determination date (for example, “order date” or “bunkering date”) may be adopted. Further, it may be made possible for a user to select whether to use the current fuel price or the fuel price on the bunkering price determination date.

(17) In the embodiment described above, the draft used when bunkering plan management server device 11 specifies the fuel consumption in each of the unit sailing segments of ship 9 is a draft specified according to draft trim reference data (FIG. 8) in accordance with the load amount and amount of fuel remaining. That is to say, this draft is a value that is estimated based on the load amount, and not the measured draft. In place thereof, a configuration in which ship terminal device 12-1 transmits data indicating draft measured when cargo handling is complete at each of the ports, for example, to bunkering plan management server device 11 may be adopted, and bunkering plan management server device 11 may use the measured draft to specify fuel consumption.

In the embodiment described above the trim used by bunkering plan management server device 11 to specify the fuel consumption in each of the unit sailing segments of ship 9 is trim specified according to the draft trim reference data (FIG. 8) in accordance with the load amount and amount of fuel remaining. That is to say, this trim is a recommended value corresponding to draft that is estimated based on load amount, and not the measured trim. In place thereof, a configuration in which ship terminal device 12-1 transmits data indicating trim measured when cargo handling is complete at each of the ports, for example, to bunkering plan management server device 11 may be adopted, and bunkering plan management server device 11 may use the measured trim to specify fuel consumption.

(18) In the embodiment described above, the trim used by bunkering plan management server device 11 to specify the fuel consumption in each of the unit sailing segments of ship 9 is a recommended value specified according to the draft trim reference data (FIG. 8). In place thereof, a configuration may be adopted in which trim reference data indicating the estimated value for trim corresponding to various combinations of load amount and amount of fuel remaining, for example, is prepared in advance for each ship, and bunkering plan management server device 11 specifies the estimated value for a trim corresponding to load amount and amount of fuel remaining in accordance with the trim reference data and uses this value to calculate fuel consumption. Since it is usually difficult to estimate the trim from the total amount of the load amount and amount of fuel remaining, it is necessary for the trim reference data to be prepared as data indicating the estimated value for trim corresponding to information related to more detailed load amount and amount of fuel remaining such as load amount per area or amount of fuel remaining per tank of the ship.

(19) In the embodiment described above, a configuration in which bunkering plan management server device 11, ship terminal device 12-1, land-side terminal device 12-2 and weather and marine information distribution server device 13 are implemented by causing a general computer to carry out processes according to an application program is adopted. In place thereof, one or more of bunkering plan management server device 11, ship terminal device 12-1, land-side terminal device 12-2 and weather and marine information distribution server device 13 may be configured as a so-called dedicated device.

The present invention is identified as a device exemplified by bunkering plan management server device 11, a program that causes a computer to function as the device exemplified by bunkering plan management server device 11, a computer-readable recording medium that continuously records the program, and a method for the processes carried out by the device exemplified by bunkering plan management server device 11.

### EXPLANATION OF REFERENCE NUMERALS

1 . . . bunkering plan support system, 8 . . . communication satellite, 9 . . . ship, 10 . . . computer, 11 . . . bunkering plan management server device, 12 . . . terminal device, 13 . . . weather and marine information distribution server device, 101 . . . CPU, 102 . . . memory, 103 . . . communication interface, 104 . . . input/output interface, 111 . . . storage unit, 112 . . . acquisition unit, 113 . . . bunkering plan generation unit, 114 . . . fuel cost calculation unit, 115 . . . notification data generation unit, 116 . . . output unit, 1121 . . . fuel consumption acquisition unit, 1122 . . . port-to-port distance acquisition unit, 1123 . . . draft trim reference data acquisition unit, 1124 . . . voyage plan acquisition unit, 1125 . . . remaining fuel condition acquisition unit, 1126 . . . voyage restriction acquisition unit, 1127 . . . fuel price acquisition unit, 1128 . . . weather and marine element acquisition unit, 1129 . . . current status data acquisition unit

What is claimed is:

1-11. (canceled)

12. A device comprising:
a fuel consumption acquisition unit that acquires fuel consumption data indicating fuel consumption per distance unit corresponding to sailing speed of a ship;
a port-to-port distance acquisition unit that acquires, for each of a plurality of ports, port-to-port distance data indicating a distance between the port and one or more ports other than the port from among the plurality of ports;
a voyage plan acquisition unit that acquires voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports;
an remaining fuel condition acquisition unit that acquires remaining fuel condition data indicating conditions related to an amount of fuel remaining on the ship while the ship is sailing the sailing route indicated by the voyage plan data;
a remaining fuel acquisition unit that acquires remaining fuel data indicating a current amount of fuel remaining on the ship;
a fuel price acquisition unit that acquires fuel price data indicating a fuel price at each of a plurality of bunkering ports at which bunkering of the ship is possible from among the plurality of ports;
a bunkering plan generation unit that generates bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data;
a fuel costs calculation unit that calculates fuel costs in the bunkering plan indicated by the bunkering plan data based on the bunkering plan data and the fuel price data, and generates fuel cost data indicating the fuel costs;
a notification data generation unit that generates notification data indicating the bunkering plan indicated by the bunkering plan data and the fuel costs indicated by the fuel cost data; and
an output unit that outputs the notification data.

13. The device according to claim 12, wherein:
the bunkering plan generation unit, if any of the fuel consumption data, the port-to-port distance data, the voyage plan data, the remaining fuel condition data and the remaining fuel data is modified, modifies the bunkering plan data based on the modified data,
the fuel cost calculation unit, if the bunkering plan data or the fuel price data is modified, modifies the fuel cost data based on the modified data,
the notification data generation unit, if the bunkering plan data or the fuel cost data is modified, generates notification data after modification indicating notification of the bunkering plan or the fuel costs indicated by the modified data, and
the output unit outputs the notification data after modification.

14. The device set according to claim 12, wherein:
the bunkering plan generation unit, if a plurality of bunkering plans are specified, generates a plurality of sets of bunkering plan data each indicating any of the plurality of bunkering plans,
the fuel cost calculation unit, if a plurality of sets of bunkering plan data is generated by the bunkering plan generation unit, calculates, in connection with each of the plurality of sets of bunkering plan data, fuel costs for a bunkering plan indicated by the set of bunkering plan data based on the set of bunkering plan data and the fuel price data, and generates fuel cost data indicating the calculated fuel costs, and
the notification data generation unit, if a plurality of sets of fuel cost data is generated by the fuel costs calculation unit, generates notification data indicating minimum fuel costs indicated by each of the plurality of sets of fuel cost data, and a bunkering plan indicated by a bunkering plan data corresponding to a set of fuel cost data indicating the minimum fuel costs.

15. The device according to claim 12, wherein:
the remaining fuel condition data indicates, under a condition in which bunkering is not carried out at a predetermined number of bunkering ports from among the one or more bunkering ports selected as bunkering ports at which bunkering of the ship should be carried out, a condition that either fuel amount required for the ship to sail on the sailing route indicated by the voyage plan data is equivalent to the amount of fuel remaining, or the amount of fuel remaining exceeds the fuel amount required.

16. The device according to claim 12, wherein:
the fuel consumption data indicates fuel consumption per distance unit corresponding to a combination of sailing speed of the ship and marine or weather condition elements that affect fuel consumption when the ship sails at a same sailing speed,
the device further comprises a weather and marine element acquisition unit that acquires weather and marine element data indicating elements related to weather or marine conditions in the voyage plan indicated by the voyage plan data, and
the bunkering plan generation unit specifies, based on the fuel consumption data, fuel consumption when the ship sails on the sailing route indicated by the voyage plan data at the sailing speed indicated by the voyage plan data under a weather or marine condition with the elements indicated by the weather and marine element data, and generates the bunkering plan data based on the specified fuel consumption.

17. The device according to claim 12, wherein:
the fuel consumption data indicates fuel consumption per distance unit corresponding to at least one of draft and trim of the ship,
the bunkering plan generation unit is provided with a reference data acquisition unit that acquires reference data indicating a reference value for at least one of draft and trim corresponding to loaded amount including at least one of loaded amount of cargo and loaded amount of fuel remaining on the ship, and
the bunkering plan generation unit specifies, based on the fuel consumption data, fuel consumption when the ship with at least one of draft and trim specified based on loaded amount of the ship sails on the sailing route indicated by the voyage plan data at the sailing speed indicated by the voyage plan data, and generates the bunkering plan data based on the specified fuel consumption.

18. The device according to claim 12, further comprising:
a remaining distance to be sailed acquisition unit that acquires remaining distance to be sailed data indicating a distance from a current position of the ship to a port at which the ship calls next,
wherein:
the bunkering plan generation unit generates the bunkering plan data based on the remaining distance to be sailed data.

19. The device according to claim 12, wherein:
the voyage plan data indicates, with regard to each of one or more ports of call at which the ship calls from among the plurality of ports, a time at which the ship arrives at the port of call and a time at which the ship departs from the port of call, and
the bunkering plan generation unit specifies a bunkering plan in which one or more of the one or more ports of call on the sailing route indicated by the voyage plan data are selected as bunkering ports at which the ship is bunkered.

20. A program stored on a non-transitory computer-readable medium for causing a computer to execute:
a process for acquiring fuel consumption data indicating fuel consumption per distance unit corresponding to sailing speed of a ship;
a process for acquiring, for each of a plurality of ports, port-to-port distance data indicating a distance between the port and one or more ports other than the port from among the plurality of ports;
a process for acquiring voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports;
a process for acquiring remaining fuel condition data indicating conditions related to an amount of fuel remaining on the ship while the ship is sailing the sailing route indicated by the voyage plan data;
a process for acquiring remaining fuel data indicating a current amount of fuel remaining on the ship;
a process for acquiring fuel price data indicating a fuel price at each of a plurality of bunkering ports at which bunkering of the ship is possible from among the plurality of ports;
a process for generating bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data;
a process for calculating fuel costs in the bunkering plan indicated by the bunkering plan data based on the bunkering plan data and the fuel price data, and generating fuel cost data indicating the fuel costs;
a process for generating notification data indicating the bunkering plan indicated by the bunkering plan data and the fuel costs indicated by the fuel cost data; and
a process for outputting the notification data.

21. A computer-readable recording medium that continuously records a program for causing a computer to execute:
a process for acquiring fuel consumption data indicating fuel consumption per distance unit corresponding to sailing speed of a ship;
a process for acquiring, for each of a plurality of ports, port-to-port distance data indicating a distance between the port and one or more ports other than the port from among the plurality of ports;
a process for acquiring voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports;
a process for acquiring remaining fuel condition data indicating conditions related to an amount of fuel remaining on the ship while the ship is sailing the sailing route indicated by the voyage plan data;
a process for acquiring remaining fuel data indicating a current amount of fuel remaining on the ship;
a process for acquiring fuel price data indicating a fuel price at each of a plurality of bunkering ports at which bunkering of the ship is possible from among the plurality of ports;
a process for generating bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data;
a process for calculating fuel costs in the bunkering plan indicated by the bunkering plan data based on the bunkering plan data and the fuel price data, and generating fuel cost data indicating the fuel costs;
a process for generating notification data indicating the bunkering plan indicated by the bunkering plan data and the fuel costs indicated by the fuel cost data; and
a process for outputting the notification data.

22. A method comprising:
a step for a device to acquire fuel consumption data indicating fuel consumption per distance unit corresponding to sailing speed of a ship;
a step for the device to acquire, for each of a plurality of ports, port-to-port distance data indicating a distance between the port and one or more ports other than the port from among the plurality of ports;
a step for the device to acquire voyage plan data indicating a voyage plan including a sailing route of a voyage of the ship and a voyage schedule of the voyage, the voyage schedule including a time of departure from a departure port of the voyage and a time of arrival at a destination port of the voyage from among the plurality of ports;
a step for the device to acquire remaining fuel condition data indicating conditions related to an amount of fuel remaining on the ship while the ship is sailing the sailing route indicated by the voyage plan data;
a step for the device to acquire remaining fuel data indicating a current amount of fuel remaining on the ship;
a step for the device to acquire fuel price data indicating a fuel price at each of a plurality of bunkering ports at which bunkering of the ship is possible from among the plurality of ports;
a step for the device to generate bunkering plan data indicating, as a bunkering plan, a bunkering amount for the ship at each of one or more bunkering ports selected from among the plurality of bunkering ports, which makes it possible for the ship to undertake the voyage according to the voyage plan indicated by the voyage plan data while satisfying the conditions indicated by the remaining fuel condition data, based on the fuel consumption data, the port-to-port distance data, the voyage plan data, the remaining fuel condition data and the remaining fuel data;
a step for the device to calculate fuel costs in the bunkering plan indicated by the bunkering plan data based on the bunkering plan data and the fuel price data, and generate fuel cost data indicating the fuel costs;
a step for the device to generate notification data indicating the bunkering plan indicated by the bunkering plan data and the fuel costs indicated by the fuel cost data; and
a step for the device to output the notification data.
